(19) United States
(12) Patent Application Publication
(10) Pub. No.: US 2026/0245123 A1
(43) Pub. Date: Aug. 20, 2026

(54) SYSTEMS AND METHODS FOR COMPUTER-IMPLEMENTED CONSTRUCTION ESTIMATION WITH HYBRID ARTIFICIAL INTELLIGENCE ARCHITECTURE AND CONFIDENCE-DRIVEN ITERATIVE REFINEMENT

(71) Applicant: BOAR SYSTEMS CORPORATION, Raleigh, NC (US)

(72) Inventor: John Rogers UHRIN, JR., Raleigh, NC (US)

(21) Appl. No.: 19/641,800

(22) Filed: Apr. 8, 2026

Related U.S. Application Data
(63) Continuation-in-part of application No. 18/982,936, filed on Dec. 16, 2024.

(51) Int. Cl. G06Q 30/0283; G06Q 50/08

(52) U.S. Cl. CPC G06Q 30/0283; G06Q 50/08

(57) ABSTRACT

A computer-implemented method for generating a cost estimate for a construction item associated with a construction project may include receiving a natural language description of the construction item from a user, extracting at least one specification field from the received natural language description, assigning a confidence score and a cost impact score to the at least one specification field, generating a cost estimate for the construction item based on the at least one specification field in response to a combination of the confidence score and the cost impact score satisfying a predetermined criteria, or generating one or more requests for additional information about the construction item in response to the combination of the confidence score and the cost impact score not satisfying the predetermined criteria. Related systems, hybrid artificial intelligence architectures, domain-specific model fine-tuning methods, and non-transitory computer-readable media are also discussed.

### RELATED APPLICATION

This application is a continuation-in-part of and claims priority to U.S. Patent Application No. 18/982,936, filed on Dec. 16, 2024, in the United States Patent and Trademark Office, the disclosure of which is incorporated herein by reference in its entirety.

### TECHNICAL FIELD

The present disclosure generally relates to systems and methods for computer-implemented construction estimation.

### BACKGROUND

Construction projects commonly involve estimating costs, materials, labor, equipment, durations, and other project-related parameters. Accurate estimation can be important for project planning, bidding, scheduling, budgeting, and resource allocation. However, generating such estimates may be difficult as construction projects often vary significantly in scope, site conditions, design requirements, and execution constraints.

In many cases, the accuracy of an estimation depends on the availability of sufficient project information and on the experience and judgment of the person preparing the estimate. As a result, estimation processes may be time-consuming, inconsistent, and susceptible to error or variability. In some cases, project information may be incomplete, uncertain, or subject to change during the estimation process. For example, tariffs and logistics risks may create pricing uncertainties, modern building designs may require complex analysis across multiple technical fields, and environmental regulations may demand precise material optimization. This may further complicate preparation of reliable estimates. Moreover, differences in user experience, input assumptions, and project-specific conditions may lead to differences in estimation results across users or systems.

### SUMMARY

A computer-implemented method for generating a cost estimate for a construction item associated with a construction project, according to some embodiments herein, may include (a) receiving, via a user interface, a natural language description of the construction item from a user, (b) extracting, via a processor, a plurality of specification fields from the received natural language description, where each of the plurality of specification fields includes one or more of a quantity, a material type, a dimension, a quality specification, and an application context of the construction item, (c) for each of the plurality of specification fields, assigning, via the processor (i) a confidence score selected from a HIGH confidence score indicating that there is no ambiguity in information contained in the plurality of specification fields, a MEDIUM confidence score indicating that information in the plurality of specification fields can be inferred from the received natural language description, a LOW confidence score indicating that there is uncertainty about the information contained in the plurality of specification fields, or a NO confidence score indicating that there is insufficient information in the plurality of specification fields, and (ii) a cost impact score selected from a CRITICAL cost impact score indicating that a cost for the construction item cannot be obtained from information contained in the plurality of specification fields, a HIGH cost impact score indicating that a cost for the construction item may vary by 20% or more based on the information contained in the plurality of specification fields, a MEDIUM cost impact score indicating that a cost for the construction item may vary by 10% - 20% based on the information contained in the plurality of specification fields, or a LOW cost impact score indicating that a cost for the construction item may vary by less than 10% based on the information contained in the plurality of specification fields, (d) applying a decision algorithm, via the processor, to determine whether to request additional information from the user, where the decision algorithm includes (i) determining a first condition is satisfied when at least one specification field has a confidence score of NO and a cost impact score of CRITICAL, and (ii) determining a second condition is satisfied when at least two specification fields each have a confidence score of NO and a cost impact score of HIGH, (e) in response to either the first condition or the second condition being satisfied (i) generating, via the processor, one or more targeted questions directed to ones of the plurality of specification fields having a confidence score of NO or LOW and a cost impact score of CRITICAL or HIGH, (ii) presenting, via the processor, the one or more questions to the user via a display, (iii) receiving, via the processor, user responses to the one or more questions, (iv) updating, via the processor, the plurality of specification fields based on the user responses, (v) reassigning, via the processor, confidence scores and cost impact scores for the updated specification fields, and (vi) repeating steps (d) through (e) until neither the first condition nor the second condition is satisfied, (f) in response to neither the first condition nor the second condition being satisfied (i) applying, via the processor, intelligent defaults derived from construction context data for any specification field having a confidence score below HIGH, and (ii) generating, via the processor, a cost estimate for the construction item based on the plurality of specification fields and presenting the cost estimate to the user.

In some embodiments, generating, via the processor, the one or more targeted questions includes formulating at least one question that inquires about application and use case rather than technical specifications, thereby enabling users without technical expertise to provide information from which technical specifications can be inferred, providing range-based answer options for each question, where each answer option is associated with implied technical specifications, providing at least one industry-standard default option derived from contextual information including building type, geographic location, and application context extracted from the natural language description, including an explanation of cost impact for each question, indicating how the user's response will affect the cost estimate, and prioritizing the one or more questions based on cost impact score, such that questions relating to CRITICAL cost impact fields are presented before questions relating to HIGH cost impact fields.

In some embodiments, repeating steps (d) through (e) is limited to a maximum of three iterations, and where after a third iteration if the first condition or second condition remains satisfied, generating, via the processor, a preliminary cost estimate with an uncertainty indicator reflecting the missing specification fields, or presenting, via the processor, a notification to the user identifying the specification fields that remain unresolved and their potential cost impact.

In some embodiments, generating the one or more targeted questions includes evaluating each specification field to identify fields where the confidence score is NO or LOW and the cost impact score is CRITICAL or HIGH, excluding from questioning any specification field where the cost impact score is LOW, regardless of confidence score, and for specification fields having a MEDIUM confidence score and HIGH or CRITICAL cost impact score, generating a confirmation question presenting an inferred cost estimate and requesting user verification.

In some embodiments, in response to neither the first condition nor the second condition being satisfied, the method further includes generating, via the processor, a standard specification set for the construction item, where the standard specification set includes industry-standard default cost values for each specification field based on the construction context, building type, and geographic location, generating, via the processor, an economy specification set for the construction item, where the economy specification set includes specification cost values reduced by approximately 20% from the standard specification set, including one or more of reduced material strength ratings, reduced dimensions, and reduced reinforcement percentages, generating, via the processor, a heavy-duty specification set for the construction item, where the heavy-duty specification set includes specification cost values increased by approximately 20% from the standard specification set, including one or more of increased material strength ratings, increased dimensions, and increased reinforcement percentages, applying context-aware constraint rules, via the processor, to the economy specification set to prevent specification values from falling below minimum cost thresholds required by applicable building codes for the geographic location, safety requirements based on the application context, including minimum material strength for chemical exposure environments and minimum reinforcement for vibration-prone applications, and structural requirements based on the building type and intended load, generating, via the processor, a first cost estimate based on the standard specification set, generating, via the processor, a second cost estimate based on the economy specification set, generating, via the processor, a third cost estimate based on the heavy-duty specification set, and presenting, via the processor, the first, second, and third cost estimates to the user with a comparison indicating the specification differences and cost variance between each option.

In some embodiments, applying intelligent defaults includes retrieving, via the processor, contextual data for the plurality of specification fields, the contextual data including one or more of industry-standard default specifications associated with the construction item type and building classification, regional building code requirements for the geographic location associated with the construction project, including seismic zone requirements, climate considerations, and local amendments, historical project data from similar construction projects, including specification patterns and actual costs for comparable items, and current material costs and labor rates for the geographic region associated with the construction project, retrieved from a pricing database updated at intervals of 24 hours or less.

In some embodiments, generating the cost estimate includes augmenting the specification fields, via the processor, with current market data including one or more of material cost information updated on a daily basis, labor rates adjusted according to union contract cycles and prevailing wage requirements for the geographic region, building code requirements updated on an annual basis, and equipment costs adjusted based on current fuel prices and equipment availability.

In some embodiments, extracting the plurality of specification fields and assigning the confidence scores and cost impact scores includes providing the natural language description to an artificial intelligence language model, providing the language model with a structured prompt including instructions to extract specification fields from the natural language description, definitions of the confidence score levels and criteria for assignment, definitions of the cost impact score levels and criteria for assignment, and construction context data including the building type, geographic location, and project classification, receiving from the language model a structured output including the extracted specification fields with assigned confidence scores and cost impact scores, and parsing the structured output to populate a specification data structure for subsequent processing.

In some embodiments, providing construction context data to the language model includes a retrieval-augmented generation process including identifying, via the processor, specification fields having a MEDIUM confidence score, for each identified specification field, querying, via the processor, a vector database to retrieve contextual documents relevant to the specification field, the construction item type, and the building context, injecting, via the processor, the retrieved contextual documents into the structured prompt provided to the language model, and instructing, via the processor, the language model to infer specification values for the identified specification fields based on the retrieved contextual documents.

In some embodiments, the vector database includes a plurality of construction specification codes organized according to a hierarchical classification system including divisions, subdivisions, and sections, specification patterns associated with building types, including typical material specifications, dimension ranges, and quality requirements for each building classification, regional construction data including building code requirements, climate considerations, and material availability by geographic region, and historical project data including specifications and actual costs from completed construction projects, indexed by project type, geographic location, and construction item classification.

In some embodiments, the method further includes storing, via the processor, the generated cost estimate and associated specification fields in a project database, receiving, via the processor, actual cost data for the construction item from the completed construction project, comparing, via the processor, the actual cost data to the generated cost estimate to determine an estimation variance, analyzing, via the processor, the estimation variance to identify specification fields contributing to the variance, and adjusting, via the processor, intelligent default values and confidence scoring parameters based on the analysis to improve accuracy of future cost estimates.

In some embodiments, the method further includes processing, via the processor, a plurality of construction items associated with the construction project, where receiving natural language descriptions for each of the plurality of construction items, performing steps (b) through (f) for each construction item to generate individual cost estimates, aggregating the individual cost estimates to generate a total project cost estimate, identifying dependencies between construction items and sequencing the items according to construction logic, and presenting the total project cost estimate with a breakdown by construction item, including confidence indicators for each item based on the confidence scores of the underlying specification fields.

In some embodiments, presenting the first, second, and third cost estimates includes displaying, via the processor, the three cost estimates in a comparative format showing cost variance between options, for each specification field that differs between the three specification sets, displaying, via the processor, the specific values and explaining the cost impact of the difference, highlighting, via the processor, any specification fields in the economy specification set that were constrained by context-aware constraint rules and displaying the minimum allowable values, and providing, via the processor, a selection interface enabling the user to select one of the three options or to customize specification values within the displayed ranges.

In some embodiments, a system for generating construction cost estimates may include a processor, a memory coupled to the processor and storing instructions that, when executed by the processor, cause the system to perform the method, a user interface coupled to the processor that is configured to receive natural language descriptions from a user and present cost estimates and questions to the user, a specification database coupled to the processor that stores construction specification codes, material specifications, and dimension standards organized by construction item classification, a pricing database coupled to the processor that stores current material costs and labor rates organized by geographic region and updated at intervals of 24 hours or less, and a language model interface coupled to the processor and that is configured to communicate with an artificial intelligence language model for extracting specification fields and assigning confidence and cost impact scores.

In some embodiments, a non-transitory computer-readable medium may store instructions that, when executed by a processor, cause the processor to perform the method.

A computer-implemented method for generating a cost estimate for a construction item associated with a construction project, according to some embodiments herein, may include receiving, via a user interface, a natural language description of the construction item from a user, extracting, using a processor, at least one specification field from the received natural language description, where the at least one specification field is selected from the following: a quantity of the construction item, a material type of the construction item, a dimension of the construction item, a quality specification of the construction item, and an application context of the construction item, assigning a confidence score to the at least one specification field, where the confidence score is selected from a plurality of pre-defined confidence scores, each pre-defined confidence score representing a level of information specificity for the construction item in the received natural language description, assigning a cost impact score to the at least one specification field, where the cost impact score is selected from a plurality of pre-defined cost impact scores, each pre-defined cost impact score representing a level of potential cost variance for the construction item in the received natural language description, and generating, via the processor, a cost estimate for the construction item based on the at least one specification field in response to a combination of the confidence score and the cost impact score satisfying a predetermined criteria, and displaying the cost estimate via the user interface, or generating, via the processor, one or more requests for additional information about the construction item in response to the combination of the confidence score and the cost impact score not satisfying the predetermined criteria, and displaying the one or more requests for additional information via the user interface.

In some embodiments, the confidence score is one of the following: a high confidence score indicating that there is no ambiguity in information contained in the at least one specification field, a medium confidence score indicating that information in the at least one specification field can be inferred from the received natural language description, a low confidence score indicating that there is uncertainty about the information contained in the at least one specification field, and a no confidence score indicating that there is insufficient information in the at least one specification field, and where the cost impact score is one of the following: a critical cost impact score indicating that a cost for the construction item cannot be obtained from information contained in the at least one specification field, a high cost impact score indicating that a cost for the construction item may vary by 20% or more based on the information contained in the at least one specification field, a medium cost impact score indicating that a cost for the construction item may vary by 10% - 20% based on the information contained in the at least one specification field, and a low cost impact score indicating that a cost for the construction item may vary by less than 10% based on the information contained in the at least one specification field.

In some embodiments, the predetermined criteria is not satisfied when either of the following occur: the at least one specification field has a confidence score of NO and a cost impact score of CRITICAL, or the at least one specification field includes two specification fields and each specification field has a confidence score of NO and a cost impact score of HIGH, and where generating, via the processor, one or more requests for additional information about the construction item includes generating one or more targeted questions directed to the at least one specification field having a confidence score of NO or LOW and a cost impact score of CRITICAL or HIGH, and displaying the one or more targeted questions via the user interface.

In some embodiments, the predetermined criteria is satisfied when the at least one specification field has a confidence score of MEDIUM and a cost impact score of CRITICAL or HIGH, and where the method further includes generating, via the processor, one or more confirmation questions about the generated cost estimate and requesting user verification via the user interface.

In some embodiments, the method further includes receiving, via the user interface, a response to the one or more targeted questions, updating, via the processor, the at least one specification field using the received response, reassigning, via the processor, a confidence score to the updated at least one specification field, reassigning, via the processor, a cost impact score to the updated at least one specification field, generating, via the processor, a cost estimate for the construction item based on the updated at least one specification field in response to a combination of the reassigned confidence score and the reassigned cost impact score satisfying the predetermined criteria, and displaying the cost estimate via the user interface, or generating, via the processor, one or more requests for additional information about the construction item in response to the combination of the reassigned confidence score and the reassigned cost impact score not satisfying the predetermined criteria, and displaying the one or more requests for additional information via the user interface.

In some embodiments, the predetermined criteria is not satisfied when either of the following occur: the at least one specification field has a confidence score of NO and a cost impact score of CRITICAL, or the at least one specification field includes two specification fields and each specification field has a confidence score of NO and a cost impact score of HIGH, and where generating, via the processor, one or more requests for additional information about the construction item includes generating one or more targeted questions directed to the at least one specification field having a confidence score of NO or LOW and a cost impact score of CRITICAL or HIGH, and displaying the one or more targeted questions via the user interface.

In some embodiments, generating, via the processor, one or more requests for additional information about the construction item is limited to a maximum of three iterations.

In some embodiments, after the three iterations, if the predetermined criteria is not satisfied, the method further includes generating a preliminary cost estimate with an uncertainty indicator reflecting missing information, and/or displaying, via the user interface, a notification identifying the at least one specification field that remains unresolved and a potential cost impact.

In some embodiments, generating, via the processor, the cost estimate for the construction item further includes retrieving contextual data for the at least one specification field, the contextual data including one or more of industry-standard default specifications associated with the construction item type and building classification, regional building code requirements for the geographic location associated with the construction project, including seismic zone requirements, climate considerations, and local amendments, historical project data from similar construction projects, including specification patterns and actual costs for comparable items, and current material costs and labor rates for the geographic region associated with the construction project, retrieved from a pricing database updated at intervals of 24 hours or less.

In some embodiments, generating, via the processor, the cost estimate for the construction item further includes augmenting the at least one specification field with current market data including one or more of material cost information updated on a daily basis, labor rates adjusted according to union contract cycles and prevailing wage requirements for the geographic region, building code requirements updated on an annual basis, and equipment costs adjusted based on current fuel prices and equipment availability.

In some embodiments, a system for generating construction cost estimates may include a processor, a memory coupled to the processor and storing instructions that, when executed by the processor, cause the system to perform the method.

In some embodiments, a non-transitory computer-readable medium may store instructions that, when executed by a processor, cause the processor to perform the method.

In some embodiments, the method may further employ a hybrid artificial intelligence (AI) architecture comprising a query router that decomposes estimation into subtasks and dynamically routes each subtask to an internal AI engine operating within a security boundary or an external AI service based on data sensitivity classification. The internal AI engine may process subtasks using locally-deployed machine learning models, a retrieval-augmented generation system accessing a local vector database, and proprietary assembly databases, all executing within a security boundary without transmitting project data externally.

In some embodiments, the method includes a sanitize-send-reattach pattern, where sensitive context is removed before transmitting queries to the external AI service and reattached locally after receiving results.

In some embodiments, a system for generating construction cost estimates may include a processor, a memory, a security boundary, an internal artificial intelligence engine, a local vector database, a query router, a communication interface for sanitized external queries, and a user interface.

In some embodiments, a non-transitory computer-readable medium may store instructions that, when executed by a processor, cause the processor to perform the above methods.

A computer-implemented method for generating a construction cost estimate using a hybrid artificial intelligence architecture, according to some embodiments herein, may include (a) receiving, via a user interface, project data associated with a construction project, (b) decomposing, using a processor, the construction cost estimate into a plurality of estimation subtasks, where each estimation subtask corresponds to an individual calculation, lookup, or reasoning step, (c) for each estimation subtask, determining, by a query router executing within a security boundary of a computing environment, whether the estimation subtask is to be processed by an internal artificial intelligence engine operating entirely within the security boundary or an external artificial intelligence service operating outside the security boundary, by evaluating: a data sensitivity classification assigned to data required by the estimation subtask, whether the estimation subtask requires access to private content stored within the security boundary, a task complexity score, and a cost optimization factor, (d) for each estimation subtask assigned to the internal artificial intelligence engine, processing the estimation subtask using one or more of a locally-deployed machine learning model, a retrieval-augmented generation system accessing a local vector database, and a computational cost model, all executing within the security boundary, and generating a subtask result without transmitting any project data outside the security boundary, (e) for each estimation subtask assigned to the external artificial intelligence service: generating a sanitized query by removing from the estimation subtask all data classified at or above a predetermined sensitivity threshold, including client identity, project location, financial terms, and proprietary pricing data, transmitting the sanitized query to the external artificial intelligence service, receiving an external result, and enriching the external result by reattaching, within the security boundary, context data that was removed during sanitization, (f) assembling, within the security boundary, the subtask results to generate the construction cost estimate, and (g) presenting the construction cost estimate to a user via the user interface.

In some embodiments, the project data is classified into a plurality of sensitivity tiers comprising: a first tier comprising data that is never transmitted outside the security boundary, including client identity information, project addresses, financial terms, and proprietary pricing, a second tier comprising data that is fragmented across a plurality of independent stateless requests such that no single request contains sufficient information to identify the construction project, a third tier comprising technical data that is transmitted with all identifying information removed and replaced with generic references, and a fourth tier comprising generic industry knowledge queries containing no client-specific or proprietary information, where the classification is configurable by a client administrator.

In some embodiments, for estimation subtasks assigned to the external artificial intelligence service, each sanitized query is independent and stateless, containing only the minimum data necessary for one calculation or reasoning step, and the plurality of sanitized queries are transmitted as separate unlinked requests with no shared state between requests, such that no single query contains sufficient information to determine the identity of the client or the overall scope of the construction cost estimate.

In some embodiments, generating a sanitized query comprises identifying data elements classified at or above the predetermined sensitivity threshold, removing the identified data elements and storing them in a context buffer within the security boundary, replacing the removed data elements with generic placeholders, where enriching the external result comprises mapping the external result back to the context buffer and reattaching the removed data elements within the security boundary.

In some embodiments, the internal artificial intelligence engine maintains private content within the security boundary comprising a proprietary assembly database comprising construction assembly definitions, material specifications, labor requirements, and cost relationships, client-specific engineering rules comprising construction standards, material preferences, and quality requirements, regional engineering rules comprising local building code interpretations and permitting requirements, and historical bid intelligence comprising aggregated patterns from past construction bids, where the private content is never transmitted to the external artificial intelligence service.

In some embodiments, the method further includes a vault-only processing mode where, in response to a configuration setting, the query router assigns all estimation subtasks to the internal artificial intelligence engine with zero transmissions to the external artificial intelligence service, and where the vault-only processing mode is selectable on a per-project basis.

In some embodiments, the method further includes providing a security configuration interface enabling a client administrator to select a processing mode from vault-only mode, hybrid mode, and full-external mode, and to customize sensitivity tier assignments, and providing an audit trail recording which estimation subtasks were processed internally and which were processed externally.

In some embodiments, the query router optimizes external artificial intelligence service consumption by identifying estimation subtasks resolvable by the internal artificial intelligence engine through lookup against the local vector database or application of computational cost models, processing those subtasks internally, and tracking the number of subtasks processed internally versus externally and associated cost savings.

In some embodiments, a system for generating construction cost estimates using a hybrid artificial intelligence architecture may include (a) a processor, (b) a memory coupled to the processor and storing instructions that, when executed by the processor, cause the system to perform the method, (c) a security boundary defined by one or more of a network firewall, a virtual private cloud, or an air-gapped computing environment, (d) an internal artificial intelligence engine comprising one or more machine learning models deployed within the security boundary, (e) a local knowledge base comprising a vector database of construction knowledge accessible only within the security boundary, (f) a query router configured to dynamically assign estimation subtasks to the internal artificial intelligence engine or an external artificial intelligence service based on data sensitivity classification, (g) a communication interface for transmitting sanitized queries to and receiving results from the external artificial intelligence service, and (h) a user interface for receiving project data and presenting construction cost estimates.

In some embodiments, (a) the query router assigns the estimation subtask to the internal artificial intelligence engine when any of the following conditions is satisfied: (i) the estimation subtask references data classified at or above the predetermined sensitivity threshold, (ii) the estimation subtask requires access to private content not available outside the security boundary, (iii) the estimation subtask can be resolved by lookup against the local knowledge base without requiring external language model reasoning, or (iv) the cost optimization factor indicates that internal processing is more cost-effective than external processing for the estimation subtask, (b) the query router assigns the estimation subtask to the external artificial intelligence service only when all of the following conditions are satisfied: (i) the estimation subtask does not reference data classified at or above the predetermined sensitivity threshold, (ii) the estimation subtask does not require access to private content stored within the security boundary, and (iii) the estimation subtask requires reasoning capabilities that benefit from the external artificial intelligence service.

In some embodiments, the proprietary assembly database comprises (a) a plurality of construction assemblies organized according to a hierarchical classification system, each assembly defining a complete specification for a construction element including materials, dimensions, labor, equipment, and cost relationships, (b) for each assembly, one or more variant configurations corresponding to different quality levels, regional requirements, or application contexts, (c) cost relationships derived from historical project data that associate assembly specifications with material costs, labor rates, and equipment costs by geographic region and time period, and (d) where the internal artificial intelligence engine selects and applies assemblies from the proprietary assembly database to estimation subtasks without exposing the assembly definitions, cost relationships, or selection criteria to the external artificial intelligence service.

In some embodiments, applying client-specific engineering rules comprises (a) maintaining, for each client, a rules profile comprising the client's construction standards, material preferences, minimum specification thresholds, and quality requirements, (b) for estimation subtasks requiring specification decisions, applying the client's rules profile to constrain or override default specifications, (c) for estimation subtasks requiring regional knowledge, applying regional engineering rules to adjust specifications, costs, or methods based on local practices and regulatory interpretations, and (d) where the rules profiles and regional knowledge are applied within the security boundary and the external artificial intelligence service receives only the resulting specification values, not the rules that produced them.

In some embodiments, the retrieval-augmented generation system operating within the security boundary comprises (a) a vector database containing a plurality of document chunks derived from construction knowledge sources including: construction curriculum materials, design specifications, regulatory documents, cost databases, and completed project documentation, (b) an embedding model executing within the security boundary that converts estimation subtask queries into vector representations for similarity search against the vector database, (c) a retrieval process that identifies and returns relevant document chunks from the vector database to provide context for the internal artificial intelligence engine's processing of the estimation subtask, and (d) where the entire retrieval-augmented generation process, including embedding generation, similarity search, document chunk retrieval, and context-augmented reasoning, executes within the security boundary with no external data transmission.

In some embodiments, the method further includes a document recognition subsystem operating within the security boundary, the document recognition subsystem comprising (a) receiving construction documents uploaded by a user, the construction documents comprising one or more of: architectural blueprints, engineering specifications, change orders, and bid documents, (b) extracting, using optical character recognition and document parsing models executing within the security boundary, structured data from the construction documents including: dimensions, material specifications, quantities, and construction element descriptions, (c) mapping the extracted structured data to a standardized construction classification system comprising divisions, subdivisions, and sections, and (d) providing the mapped structured data to the query router as project data for decomposition into estimation subtasks, where the uploaded construction documents and all extracted data remain within the security boundary and are not transmitted to the external artificial intelligence service.

In some embodiments, a non-transitory computer-readable medium may store instructions that, when executed by a processor, cause the processor to perform the method.

A computer-implemented method for generating a construction-domain artificial intelligence model, according to some embodiments herein, may include (a) selecting a base large language model comprising a pre-trained model with a parameter count of at least one billion parameters, (b) assembling a construction-domain training corpus comprising construction curriculum materials, specification documents, assembly definitions with associated cost relationships, historical construction cost estimates, and building code documents, (c) fine-tuning the base large language model on the construction-domain training corpus using a parameter-efficient fine-tuning technique that modifies fewer than ten percent of the base model parameters, producing a construction-domain model, (d) deploying the construction-domain model within a security boundary of a computing environment, and € integrating the construction-domain model into a construction cost estimation pipeline as a domain specialist model that processes estimation subtasks requiring construction-specific knowledge, where the construction-domain training corpus and resulting model weights remain within the security boundary.

In some embodiments, assembling the construction-domain training corpus comprises converting construction curriculum materials into structured training examples comprising input-output pairs associating construction estimation questions with expert-validated answers, augmenting the training examples with assembly data from an assembly database, and validating coverage across all divisions of a recognized construction classification standard.

Other devices, systems, and/or methods according to some embodiments will become apparent to one with skill in the art upon review of the following drawings and detailed description. It is intended that all such additional embodiments, in addition to any and all combinations of the above embodiments, be included within this description, be within the scope of the present disclosure, and be protected by the accompanying claims.

### BRIEF DESCRIPTION OF THE DRAWINGS

FIG. 1A is a flowchart illustrating example operations of a computer-implemented method for generating a cost estimate for a construction item associated with a construction project, according to some embodiments of the present disclosure.

FIG. 1B is a decision flow diagram illustrating example operations of the computer-implemented method of FIG. 1A, according to some embodiments of the present disclosure.

FIGS. 1C, 1D and 1E are schematic diagrams illustrating example user interfaces for receiving user input, according to some embodiments of the present disclosure.

FIGS. 1F, 1G, and 1H are schematic diagrams illustrating example user interfaces for outputting specification sets for a construction item, according to some embodiments of the present disclosure.

FIGS. 2A and 2B are schematic block diagrams illustrating example computing systems for generating construction cost estimates, according to some embodiments of the present disclosure.

FIG. 3 is a schematic diagram illustrating an example network useable to facilitate a computer-implemented method for generating a cost estimate for a construction item associated with a construction project, according to some embodiments of the present disclosure.

FIG. 4 is a schematic block diagram illustrating an example hybrid artificial intelligence architecture with a query router and security boundary for construction cost estimation, according to some embodiments of the present disclosure.

### DETAILED DESCRIPTION

Construction estimation systems may be used to generate projected costs, quantities, labor requirements, material requirements, durations, schedules, and other project-related outputs based on available project information. Conventional construction estimation systems, however, may suffer from various shortcomings. For example, some existing systems may require extensive project-specific technical inputs before an estimate can be generated, thereby placing substantial demands on a user to provide information that may be unavailable, uncertain, or outside the expertise of the user. Other existing systems may reduce input requirements by relying on generalized defaults or simplified workflows, but such approaches may reduce the ability of the resulting estimates to accurately reflect the particular characteristics of a given project.

As a result, conventional systems may exhibit reduced flexibility, increased user burden, and inconsistent estimation performance, particularly when project information is incomplete or when users are unable to provide detailed specifications at the outset. For example, some users may lack the technical expertise, time, or information needed to specify all relevant estimation parameters at the outset. As another example, some users may provide incomplete, uncertain, or assumed inputs, which may reduce the reliability of an estimate. These and other limitations may reduce the usefulness of conventional systems and methods for construction estimation.

To address these and other technical problems, example embodiments of the present disclosure provide systems and methods for computer-implemented construction estimation that selectively evaluate available project information, determine the significance of missing, uncertain, or incomplete inputs, and iteratively refine one or more estimation outputs. In some embodiments, the system may determine whether missing or uncertain inputs are sufficiently significant to warrant further inquiry, additional computation, or user interaction. For example, the system may identify one or more parameters having a comparatively greater expected effect on projected cost or other estimate outputs and may prioritize refinement of those parameters relative to other parameters having a comparatively smaller expected effect.

In some embodiments, an initial analysis (or estimate) may be performed on a first set of available inputs. The system may then determine one or more confidence values, uncertainty measures, impact metrics, or other evaluation criteria associated with individual estimate components or the estimate as a whole. Based on these determinations, the system may selectively obtain additional information, revise assumptions, update estimate components, and iteratively produce refined outputs. Such operation may permit the system to provide a more adaptive and user-responsive estimation process than conventional approaches.

Computer-implemented systems and methods pursuant to example embodiments herein may provide an adaptive estimation workflow in which user interaction is dynamically guided based on confidence measures, cost impact assessments, rule-based logic, statistical models, machine learning models, or combinations thereof. This may reduce the need for users to supply complete technical specifications at the outset of the estimation process, while also avoiding reliance on overly generic assumptions. As additional information is received, inferred, or otherwise obtained, the system may update one or more estimation outputs and associated confidence measures in an iterative manner.

Accordingly, in various embodiments, the computer-implemented systems and methods described herein may provide a more efficient and technically effective approach to construction estimation by balancing input burden and estimate refinement, improving interaction with users of varying expertise levels, and facilitating generation of estimates that are responsive to project-specific conditions without requiring exhaustive initial input.

In some embodiments, the system may include one or more computing devices configured to execute stored instructions for performing the estimation and refinement operations described herein. For example, the system may include one or more processors, memory devices, data stores (e.g., databases), and communication interfaces operatively coupled to one another over one or more wired and/or wireless networks. The one or more memory devices may store program instructions that, when executed by the one or more processors, cause the system to receive project-related inputs, access one or more data sources, generate one or more estimation outputs, evaluate uncertainty or confidence associated with such outputs, selectively refine the outputs based on additional information, inferred information, or both, and perform any other operations described herein.

In some embodiments, the system may be implemented as a cloud-based platform, a server-based application, a stand-alone software application, a mobile application, or combinations thereof. For example, the system may communicate with one or more client devices associated with users, such as (but not limited to) contractor personnel, estimators, project managers, engineers, architects, owners, or other entities. The client devices may provide user interfaces through which project-related information may be submitted, reviewed, modified, or confirmed. Such information may include, for example, project type, dimensions, scope descriptors, location information, material preferences, performance requirements, schedule constraints, labor assumptions, and/or other project attributes.

In some embodiments, the system may be configured to perform an initial analysis (or estimate) based on a first set of available inputs, which may include expressly received user inputs (e.g., user inputs received via a natural language description), previously stored project data, reference data, third-party data, inferred data, derived data, or combinations thereof. The initial analysis may include one or more projected outputs, such as estimated costs, material quantities, labor requirements, durations, schedules, line items, assemblies, allowances, contingencies, and/or other project-related metrics. In some embodiments, the system may further associate one or more portions of the analysis with corresponding confidence values, uncertainty indicators, sensitivity measures, and/or impact assessments.

The system may further determine whether one or more estimate components should be refined based on one or more decision criteria. For example, the system may evaluate whether a missing, incomplete, assumed, or uncertain parameter is likely to have a threshold level of effect on projected cost, schedule, quantity, or another output. Parameters determined to have relatively greater significance may be prioritized for additional analysis, for presentation to the user, or for targeted requests (or questions) for additional information. Parameters determined to have relatively lower significance may be temporarily deferred, assigned default or inferred values, or otherwise processed without requiring immediate user intervention. In this manner, the system may selectively control the amount and type of information requested during the estimation process.

For example, refinement of the estimate may occur iteratively. For example, after receiving additional user input or obtaining supplemental information from one or more data sources, the system may update one or more estimate components and re-evaluate associated confidence values, uncertainty measures, or cost impact assessments. This process may be repeated until one or more stopping conditions are satisfied, such as when additional refinement is determined unlikely to produce a threshold level of change in the estimate, when estimate confidence satisfies a threshold condition, when a user elects to finalize the estimate, or when another suitable criterion is met. The resulting workflow may enable progressive estimate development without requiring complete technical specification at the outset.

In some embodiments, the system may further include one or more inference engines, rule sets, statistical models, optimization processes, machine learning models, or combinations thereof for determining values for missing or uncertain parameters and for assessing the likely effect of such parameters on estimation outputs. For example, the system may use historical project information, project classification data, regional data, code-related information, supplier data, productivity data, environmental data, design data, or other contextual information to infer or constrain potential values associated with one or more project parameters. In some embodiments, these determinations may be performed in conjunction with user-specific settings, organization-specific practices, and/or prior estimate data.

In some embodiments, the system may provide a guided or conversational user interaction flow through which the system selectively presents questions, prompts, range-based options, clarifications, recommendations, and/or alternative assumptions to the user. The sequence and content of such interactions may be dynamically determined based on one or more characteristics of the project, the current estimate state, previously received responses, and the estimated significance of unresolved parameters. As a result, the system may reduce unnecessary questioning while still directing user attention to information likely to materially affect estimation outputs.

In some embodiments, outputs generated by the system may be stored, transmitted, displayed, exported, or used in downstream workflows. For example, one or more estimates may be presented through a graphical user interface (GUI), transmitted to another computing system, stored in association with a project record, or used in connection with scheduling, procurement, bid generation, budgeting, reporting, or project planning operations. In some embodiments, the system may also retain information associated with prior estimation processes, including received inputs, inferred values, user selections, estimate revisions, and final outcomes, such that later estimation processes may be informed by prior estimations.

Certain embodiments of the present disclosure relate to a hybrid artificial intelligence architecture for generating construction cost estimates through confidence-driven iterative refinement, in which a query router dynamically assigns estimation subtasks to an internal artificial intelligence engine operating within a security boundary or an external artificial intelligence service based on data sensitivity classification.

Example embodiments of the present disclosure will be described in greater detail hereinafter with reference to the accompanying drawings, in which like reference numerals refer to like elements throughout. It will be understood that the embodiments described hereinafter are provided by way of example only and are not intended to limit the scope of the present disclosure.

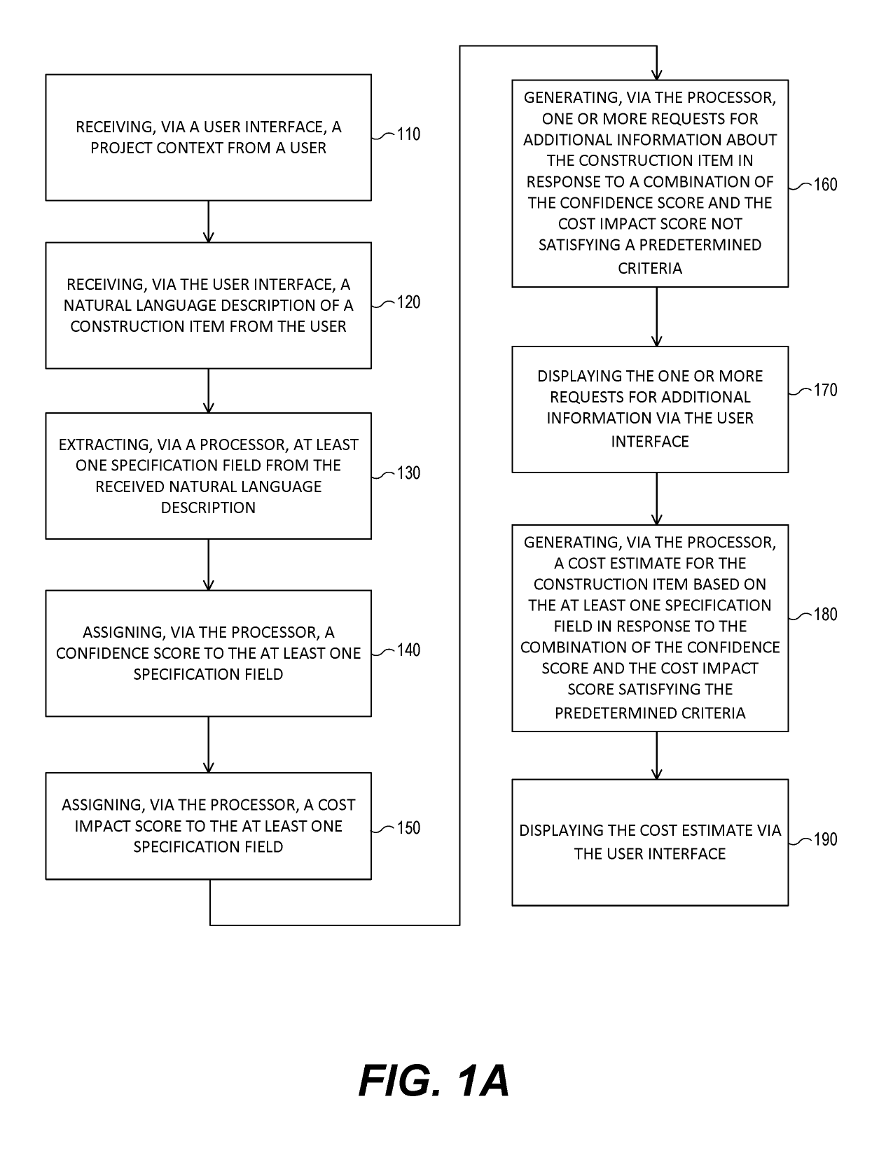

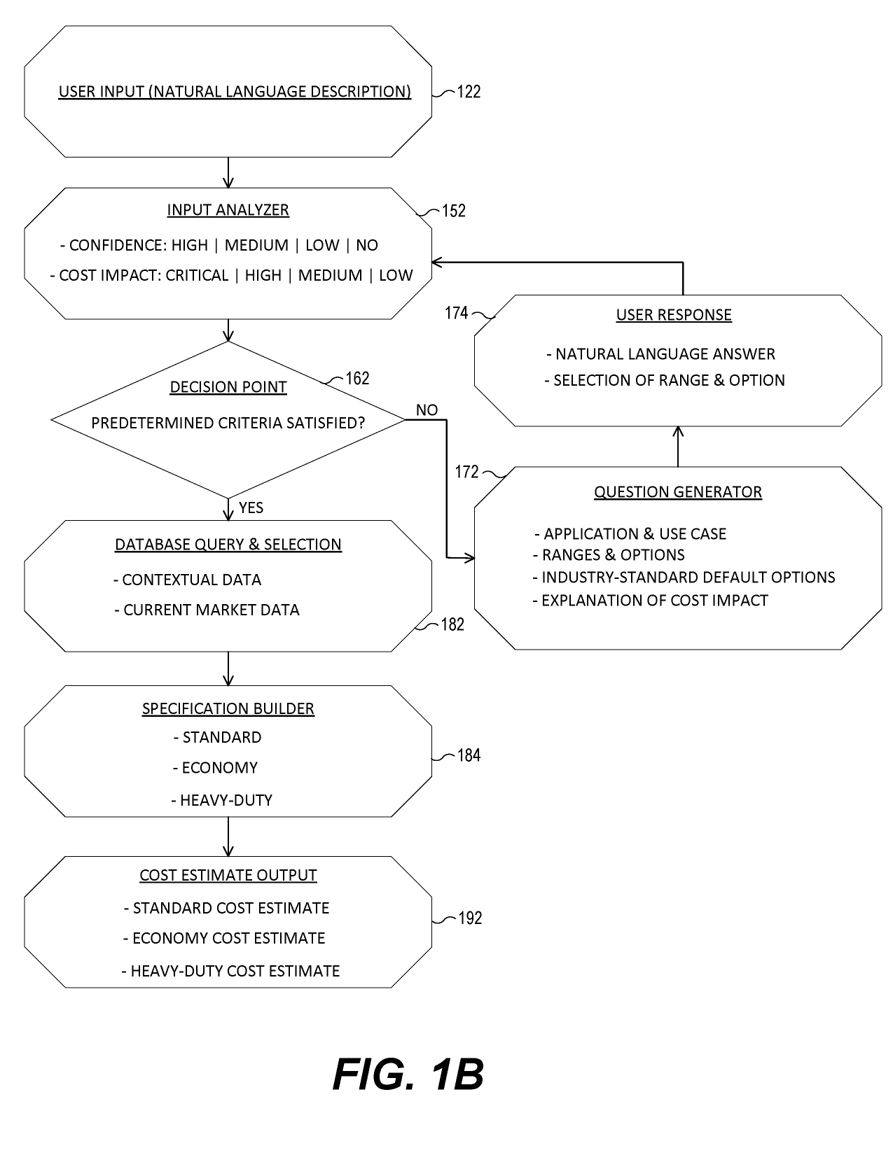

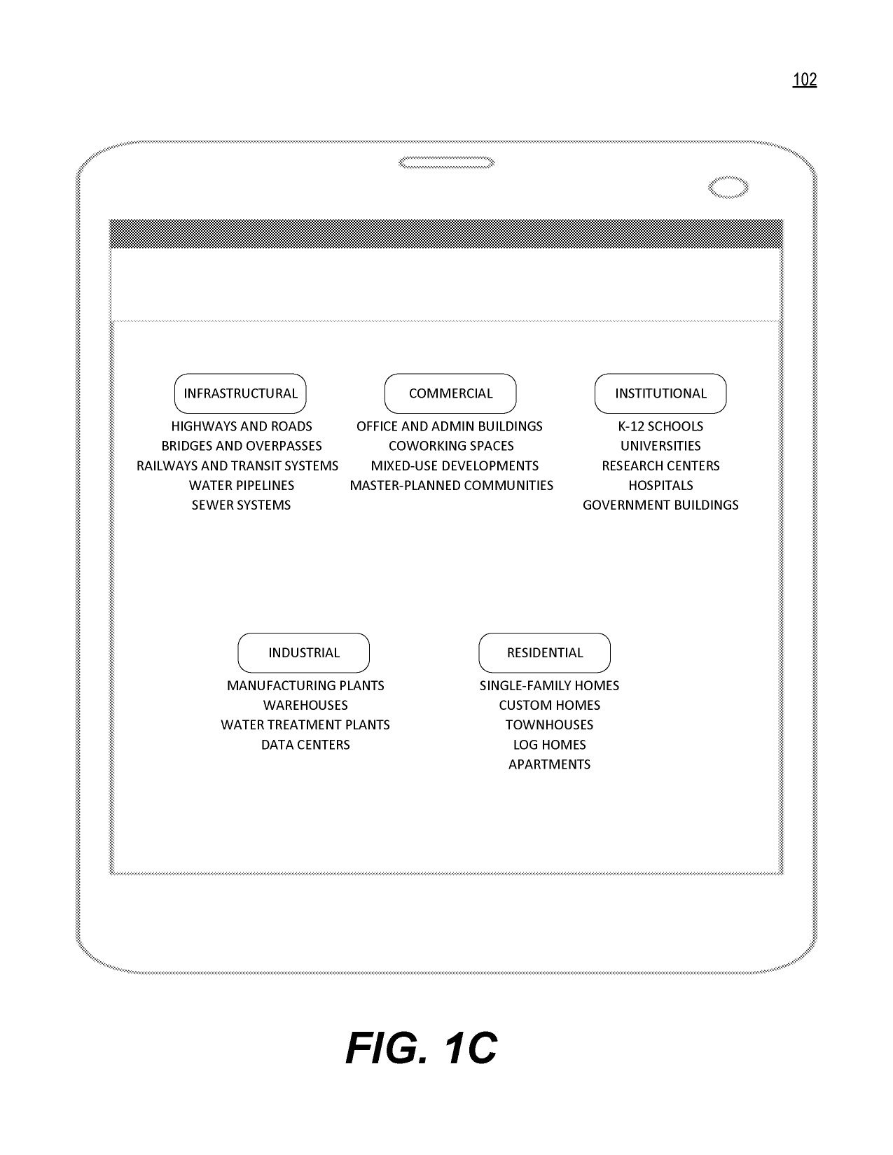

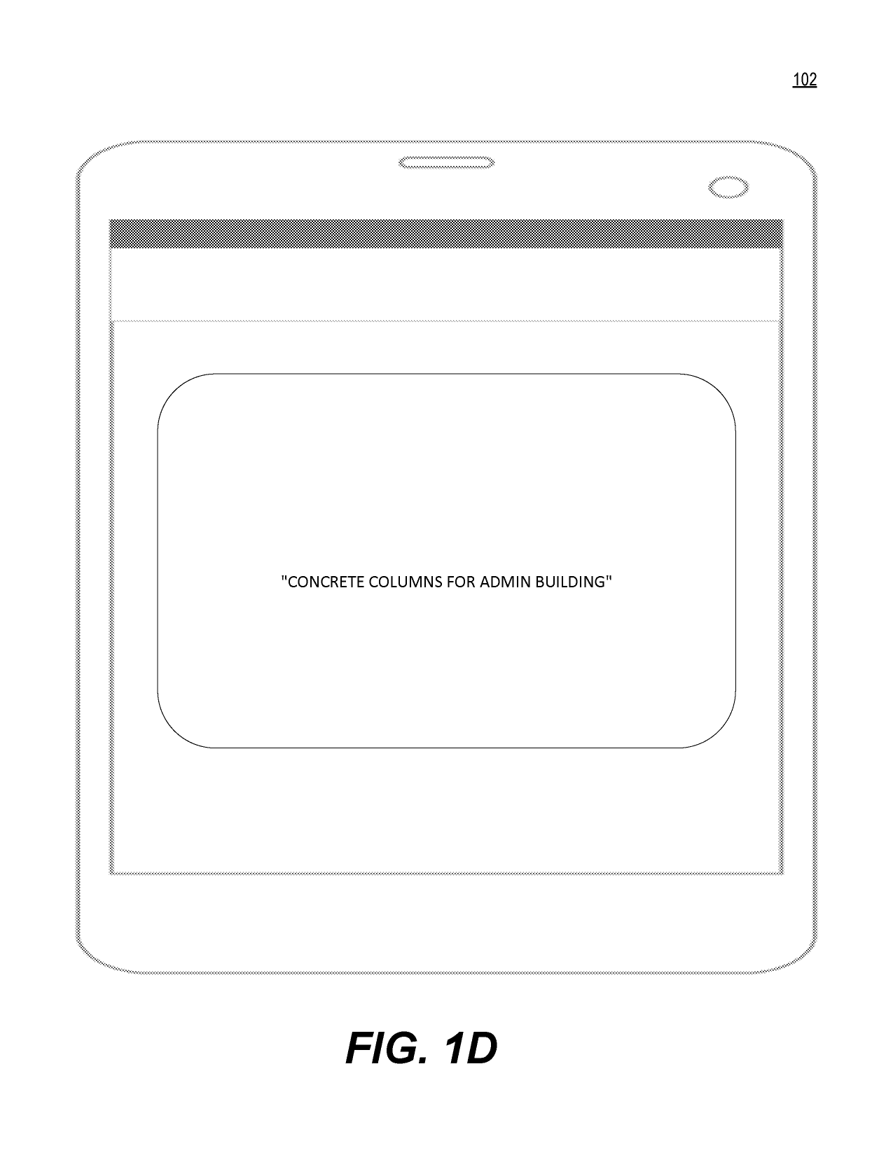

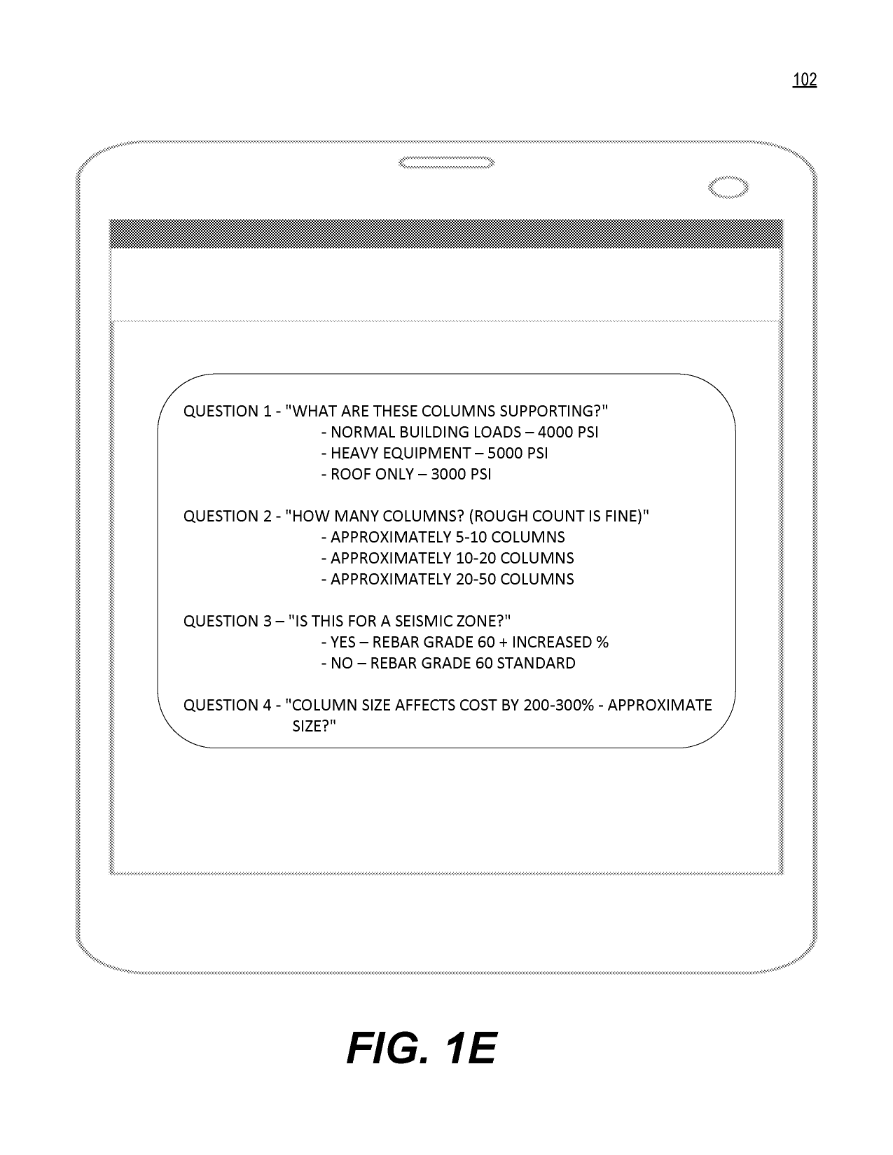

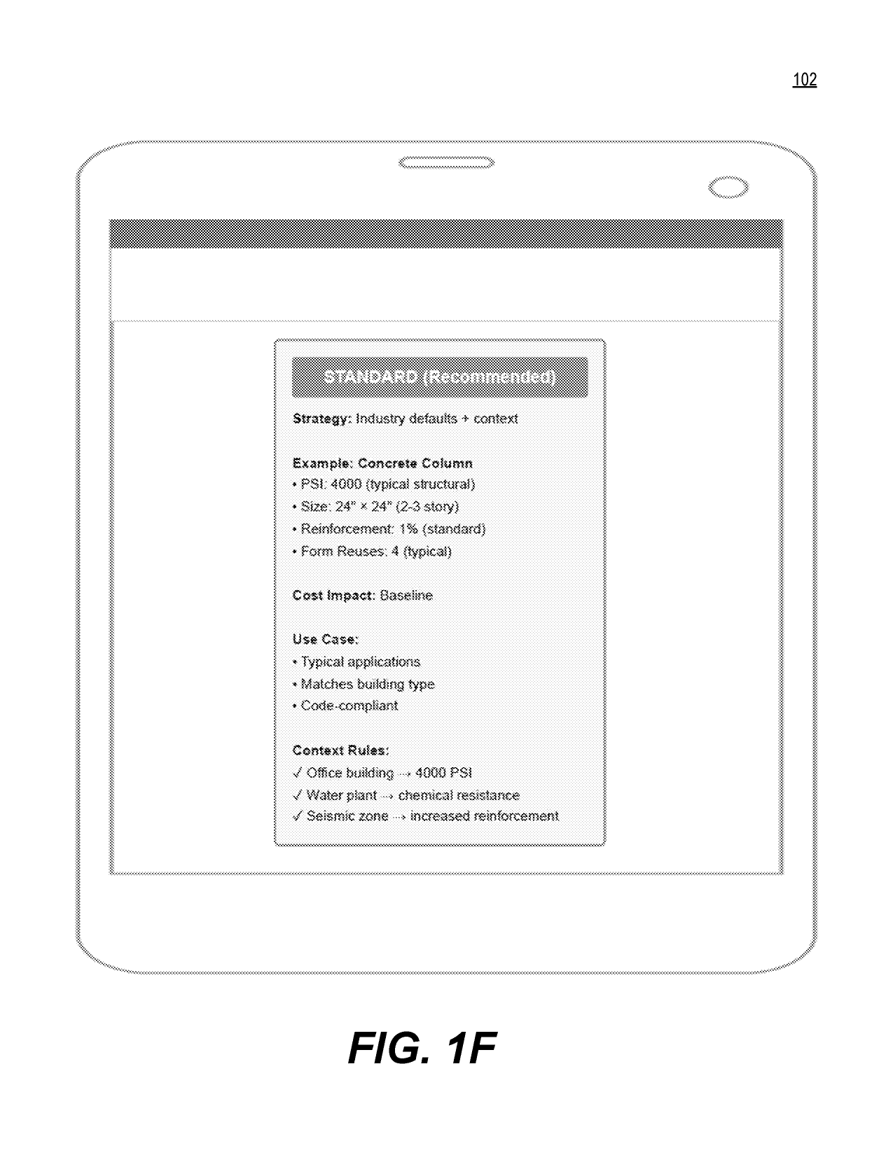

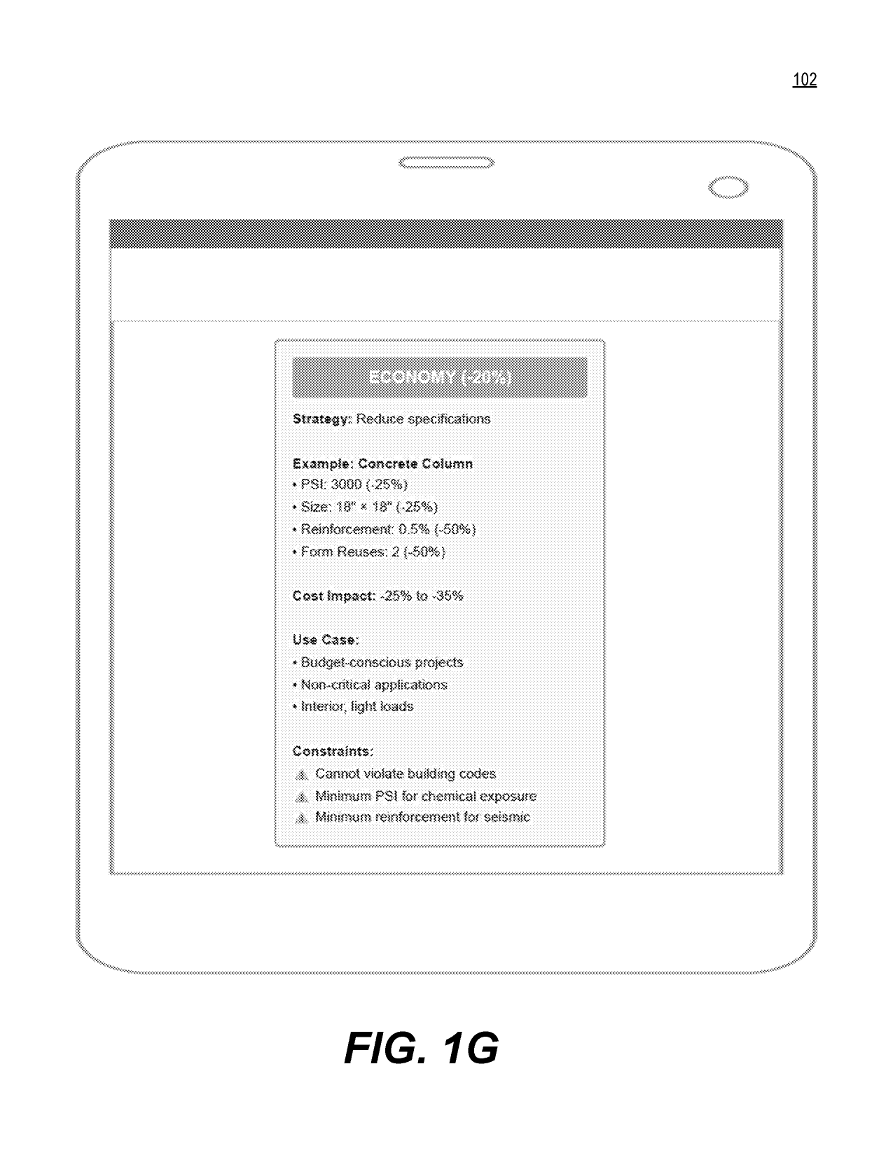

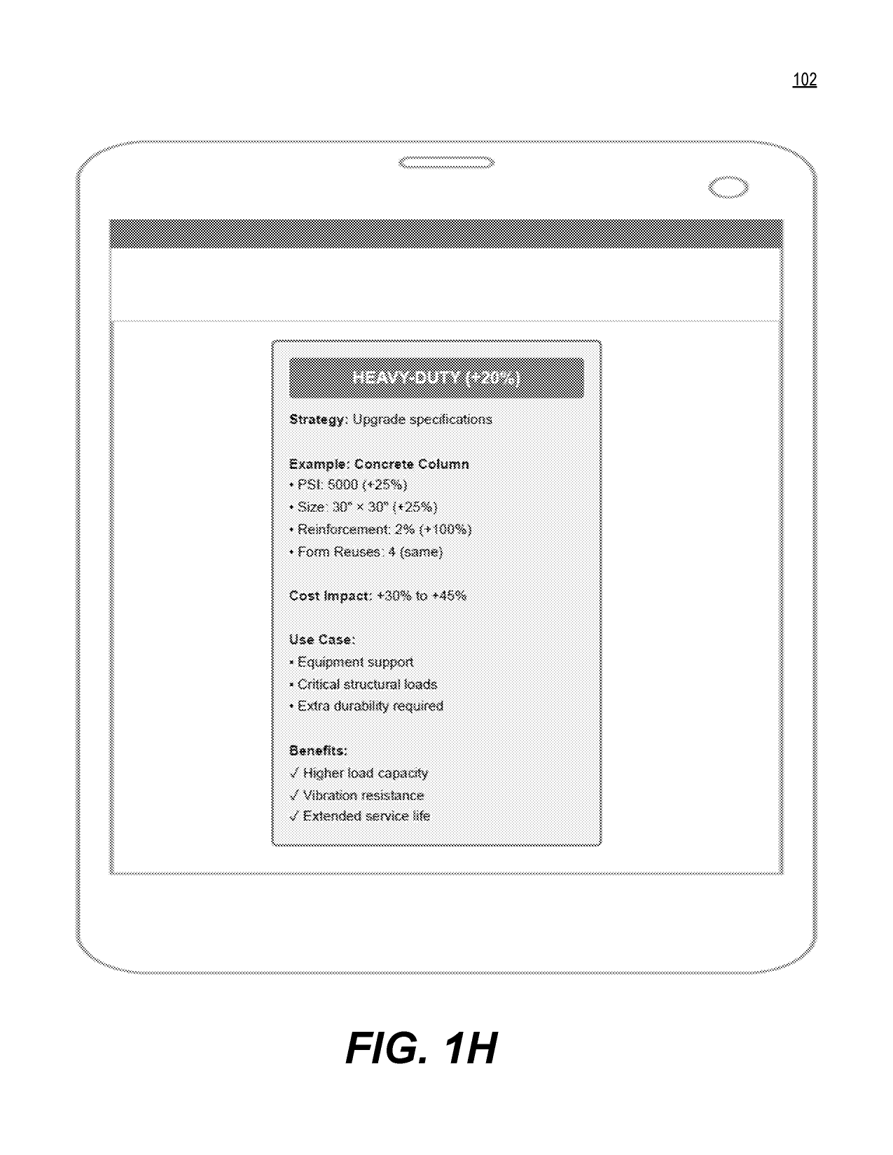

FIG. 1A is a flowchart illustrating example operations of a computer-implemented method for generating a cost estimate for a construction item associated with a construction project, according to some embodiments of the present disclosure. FIG. 1B is a decision flow diagram illustrating example operations of the computer-implemented method of FIG. 1A, according to some embodiments of the present disclosure. FIGS. 1C, 1D, and 1E are schematic diagrams illustrating example user interfaces for receiving user input, according to some embodiments of the present disclosure. FIGS. 1F, 1G, and 1H are schematic diagrams illustrating example user interfaces for outputting specification sets for a construction item, according to some embodiments of the present disclosure.

As shown in FIG. 1A, the computer-implemented method may include an operation of receiving, via a user interface, a project context from a user (Block 110 in FIG. 1A). For example, the user may input a type of construction project, a location of the construction project, and/or a building purpose for the construction project. The type of construction project, the location of the construction project, and/or the building purpose for the construction project may be received by the system to establish the project context.

As shown in FIG. 1C, the user interface 102 (which may also be referred to as a display or GUI) may include selection options for the project context. For example, the user may select infrastructural, commercial, institutional, industrial, or residential for the type of construction project. The user interface 102 may also include selection options for the building purpose for the construction project (e.g., office and admin buildings, coworking spaces, mixed-use developments, or master-planned communities for a commercial project). The user interface 102 may additionally include selection options for the location of the construction project (not shown). The user interface 102 may be displayed on an electronic device accessible by the user, such as (but not limited to) a smartphone, a tablet, a desktop computer, a laptop computer, and the like. For example, the user may be contractor personnel, estimators, project managers, engineers, architects, owners, or other entities.

The computer-implemented method may further include an operation of receiving, via the user interface, a natural language description of a construction item from the user (Block 120 in FIG. 1A). For example, the natural language description may include user-provided free-text form indicating one or more features, requirements, conditions, and/or attributes of a construction item associated with a construction project. In some embodiments, the system may use the received natural language description as an initial input for determining one or more parameters associated with the construction item and for generating a corresponding cost estimate. As shown in FIG. 1B, the natural language description may be received as input from the user at operation (i.e., step) 122. FIG. 1D illustrates an example received natural language description from the user ("concrete columns for admin building"). For example, the user interface 102 may be coupled to a processor and may be configured to receive one or more natural language descriptions from the user.

The computer-implemented method may further include an operation of extracting, via a processor, at least one specification field from the received natural language description (Block 130 in FIG. 1A). In some embodiments, the extracted specification field may include one or more of (e.g., may be selected from the following of) a quantity of the construction item, a material type of the construction item, a dimension of the construction item, a quality specification of the construction item, and an application context of the construction item.

In some embodiments, extracting the at least one specification field may include providing the received natural language description to an artificial intelligence (AI) model, for example an AI language model, together with a structured prompt configured to instruct the language model to identify and extract one or more specification fields from the natural language description. For example, the processor may provide the received natural language description and the structured prompt to the language model. The system may then receive, from the language model, a structured output including the extracted specification field(s), which may be used in generating a cost estimate for the construction item.

The computer-implemented method may further include an operation of assigning, via the processor, a confidence score to the at least one specification field (Block 140 in FIG. 1A). As noted above, the extracted specification fields may include, for example, a quantity, a material type, a quality specification, an application context, dimensions, and/or other attributes associated with the construction item. The confidence score assigned to a given specification field may indicate a degree of certainty that the extracted or inferred value of the specification field from the received natural language description accurately reflects the characteristics of the construction project.

In some embodiments, the confidence score may be selected from a plurality of pre-defined confidence scores, with each pre-defined confidence score representing a level of information specificity for the construction item in the received natural language description. The pre-defined confidence scores may include, for example, HIGH, MEDIUM, LOW, and NO confidence scores. For example, a HIGH confidence score may be assigned where a specification field is explicitly (i.e., expressly) stated in the natural language description such that there is little or no ambiguity in information contained in the specification field. A MEDIUM confidence score may be assigned where the specification field is not expressly stated in the natural language description, but information contained in the specification field may be inferred from the natural language description (e.g., based on contextual information) such that there is reasonable certainty in the information contained in the specification field. A LOW confidence score may be assigned where the specification field is only weakly inferable from the natural language description or is subject to multiple plausible interpretations such that there is uncertainty about information contained in the specification field. A NO confidence score may be assigned where the specification field is neither stated nor inferable from the natural language description such that there is insufficient information or no information contained in the specification field.

For example, a quantity of the construction item, a material type of the construction item, a dimension of the construction item, a quality specification of the construction item, and/or an application context of the construction item may be extracted from the received natural language description shown in FIG. 1D ("concrete columns for admin building"). Confidence scores may be assigned to each of the extracted specification fields. For example, the quantity of the construction item may be assigned a NO confidence score because the quantity (e.g., a number of columns) is neither stated nor inferable from the natural language description. The material of the construction item may be assigned a HIGH confidence score because the material (e.g., concrete) is explicitly stated in the natural language description. The quality specification of the construction item may be assigned a MEDIUM confidence score because the quality specification (e.g., PSI) may be implied from context with reasonable certainty based on building type/location in the natural language description (e.g., can infer 4000 PSI for columns used for office/admin buildings with reasonable certainty).

In some embodiments, the system may identify, via the processor, specification fields having a MEDIUM confidence score, and when a particular specification field is associated with a MEDIUM confidence score, the system may selectively retrieve contextual construction data to support further evaluation or inference of that specification field before generating or refining the cost estimate. For example, the construction context data may include a building type, a geographic location, historical data, cost data, and/or a project classification associated with the construction project. The building type may include data related to typical specifications for a building associated with the construction project (e.g., typical specifications for an "admin building"). The geographical location may include data related to local building codes, seismic requirements, climate considerations, and the like in a geographic region associated with the construction project. The historical data may include data related to past construction projects that are similar to the current construction project, including the actual/final specifications versus the estimates of the past construction projects. The cost data may include data related to current material prices, labor rates, equipment costs, and the like associated with the construction project. The project classification may include data related to the classification of the construction project (e.g., a commercial project classification for "admin building").

In some embodiments, assignment of the confidence scores may include providing the natural language description, and optionally one or more extracted specification fields, to an AI language model configured to evaluate completeness and certainty of the specification fields. For example, the construction context data may be provided to the language model. In some embodiments, providing the construction context data to the language model may include performing a retrieval-augmented generation (RAG) process. For example, the system may identify, via the processor, the specification fields having a MEDIUM confidence score. For each identified specification field, the processor may query a vector database to retrieve one or more contextual documents relevant to the specification field, the construction item type, and the building context. The query may be generated based on one or more extracted specification fields that are assigned a MEDIUM confidence score and may be configured to retrieve construction context data that is relevant to the one or more extracted specification fields.

In some embodiments, the vector database may store construction-related information, such as specification documents, code provisions, construction specification codes (e.g., CSI codes), historical project data, regional construction data, cost data, product data, and/or classification data. For example, the construction specification codes may be organized according to a hierarchical classification system including divisions, subdivisions, and sections. The specification documents (or patterns) may be associated with building types, including typical material specifications, dimension ranges, and quality requirements for each building classification. The regional construction data may include building code requirements, climate considerations, and/or material availability by geographic region. The historical project data may include specifications and actual costs from completed construction projects, indexed by project type, geographic location, and construction item classification.

The processor may inject the retrieved contextual documents, or information derived therefrom, into a structured prompt provided to the language model. The structured prompt may further include the received natural language description, one or more extracted specification fields, one or more confidence scores associated with the specification fields, and instructions directing the language model to infer one or more specification values for the identified specification fields based at least in part on the retrieved contextual documents. The system may then receive, from the language model, one or more inferred specification values corresponding to the identified specification fields. In some embodiments, the RAG process may be selectively performed for specification fields having a MEDIUM confidence score, rather than for all specification fields. As a result, the system may use contextual retrieval in a targeted manner to support inference of specification values where contextual guidance is likely to improve estimation accuracy, while reducing unnecessary retrieval operations for specification fields that are already sufficiently certain or that are too uncertain to support reliable inference.

As described above, the system may access and coordinate multiple data sources associated with construction estimation. These data sources may be updated at different times and at different frequencies, and thus the system may employ a tiered data storage and caching architecture configured to improve response time during user interaction while maintaining access to current and relevant information. For example, the system may include a hot cache configured to store relatively high-frequency or high-demand data in memory (e.g., in random-access memory (RAM)) for rapid access. In some embodiments, the hot cache may store a first subset of data associated with frequently requested estimation operations/data and may be refreshed according to a first refresh cycle. The system may further include a warm cache configured to store a second subset of data associated with regional pricing, commonly used contextual information, or other intermediate-frequency data. For example, the warm cache may be refreshed according to a second refresh cycle that is longer (i.e., refreshed less frequently) than the first refresh cycle (e.g., to minimize compute and network load for data that is accessed less frequently). In some embodiments, the system may further include a cold storage configured to store a third subset of data associated with historical data, less frequently used classification data, archived cost data, and/or other lower-access data that may be retrieved on demand.

The computer-implemented method may further include an operation of assigning, via the processor, a cost impact score to the at least one specification field (Block 150 in FIG. 1A). The cost impact score may indicate an expected degree to which a value of the specification field affects a cost estimate for the construction item. For example, the cost impact score may reflect whether variation in information contained in the specification field is likely to produce relatively high, moderate, low, or negligible change in one or more estimated costs associated with the construction item.

In some embodiments, the cost impact score may be selected from a plurality of pre-defined cost impact scores, with each pre-defined cost impact score representing a level of potential cost variance for the construction item in the received natural language description. The pre-defined cost impact scores may include, for example, CRITICAL, HIGH, MEDIUM, and LOW cost impact scores. For example, a CRITICAL cost impact score may indicate that a cost estimate cannot be reliably obtained (or generated) from information contained in the specification field. A HIGH cost impact score may indicate that information contained in the specification field is associated with a significant level of cost variance for the construction item (e.g., a variance where a cost estimate for the construction item may vary by 20% or more based on information contained in the specification field). A MEDIUM cost impact score may indicate that information contained in the specification field is associated with a moderate level of cost variance for the construction item (e.g., a variance where a cost estimate for the construction item may vary by 10% - 20% based on information contained in the specification field). A LOW cost impact score may indicate that information contained in the specification field is associated with a low level of cost variance (e.g., a variance where a cost estimate for the construction item may vary by less than 10% based on information contained in the specification field).

For example, a quantity of the construction item, a material type of the construction item, a dimension of the construction item, a quality specification of the construction item, and/or an application context of the construction item may be extracted from the received natural language description shown in FIG. 1D ("concrete columns for admin building"). Cost impact scores may be assigned to each of the extracted specification fields. For example, the quantity of the construction item may be assigned a CRITICAL cost impact score because the quantity (e.g., a number of columns) may lead to a cost variance that is effectively unbounded (e.g., could be 1 column, 10 columns, 100 columns, etc.), indicating that a cost estimate cannot be reliably obtained from information contained in the specification field. The quality specification of the construction item may be assigned a HIGH cost impact score because the quality specification (e.g., PSI) may lead to a significant level of cost variance for the construction item (e.g., a PSI rating of 3000 as compared to a PSI rating of 5000 may correspond to approximately a 35% difference in cost).

In some embodiments, extraction of the specification fields and assignment of the corresponding confidence scores and cost impact scores may be performed using an AI language model. For example, the processor may provide the received natural language description to the language model together with a structured prompt configured to guide extraction and evaluation of specification fields associated with the construction item. The structured prompt may include, for example, instructions directing the language model to identify and extract specification fields from the natural language description. The structured prompt may further include definitions of the confidence scores and corresponding assignment criteria, as well as definitions of the cost impact scores and corresponding assignment criteria. In some embodiments, the structured prompt may further include construction context data associated with the construction project, such as, for example, building type, geographic location, project classification, or other project-specific contextual information usable by the language model in evaluating the extracted specification fields.

In some embodiments, the processor may receive, from the language model, a structured output (e.g., in a machine-readable format) including the extracted specification fields and, for each extracted specification field, a confidence score and a cost impact score may be assigned. As shown in FIG. 1B, the processor may assign a confidence score (e.g., HIGH, MEDIUM, LOW, or NO) and a cost impact score (e.g., CRITICAL, HIGH, MEDIUM, or LOW) to each extracted specification field at operation 152.

In some embodiments, the processor may parse the structured output to populate a specification data structure for subsequent processing. For example, the specification data structure may store, for each specification field, a field identifier, an extracted or inferred value, a corresponding confidence score, a corresponding cost impact score, and optionally one or more associated metadata values. The populated specification data structure may then be used in one or more subsequent operations, such as context retrieval, follow-up question generation, specification refinement, item selection, cost estimation, and/or iterative estimate refinement.

The computer-implemented method may further include an operation of generating, via the processor, one or more requests for additional information about the construction item in response to a combination of the confidence score and the cost impact score not satisfying a predetermined criteria (Block 160 in FIG. 1A). For example, the processor may identify specification fields for which the confidence score is NO or LOW and the cost impact score is CRITICAL or HIGH, and may generate one or more targeted questions directed to the specification fields.

In some embodiments, the predetermined criteria may be determined not to be satisfied when any extracted specification field is assigned a NO confidence score and a CRITICAL cost impact score. For example, the insufficient information (or absence of information) in the specification field, together with the critical significance of the specification field for cost estimate generation, may indicate that the available project information is insufficient to proceed without further refinement, inference, or user input.

In some embodiments, the predetermined criteria may additionally or alternatively be determined not to be satisfied when two or more specification fields are each assigned a NO confidence score and a HIGH cost impact score. For example, although each specification field individually may not have a CRITICAL cost impact score, the insufficient information (or absence of information) in each specification field, together with the high significance of each specification field for cost estimate generation, may indicate that the available project information is insufficient to proceed without further refinement, inference, or user input.

Accordingly, in some embodiments, the system may determine that the predetermined criteria is not satisfied if either: (i) at least one specification field has a NO confidence score and a CRITICAL cost impact score, or (ii) two or more specification fields each have a NO confidence score and a HIGH cost impact score. In some embodiments, the processor may apply a decision algorithm to determine whether additional information should be requested from the user. As shown in FIG. 1B, the processor may apply the decision algorithm to determine whether to generate one or more requests for additional information about the construction item at operation 162. For example, the decision algorithm may evaluate the extracted specification fields based on corresponding confidence scores and cost impact scores assigned to the specification fields. The decision algorithm may determine whether unresolved or insufficiently supported specification fields are likely to materially affect the ability of the system to generate a reliable cost estimate for the construction item.

In some embodiments, the decision algorithm may determine that a first condition is satisfied when at least one specification field is assigned a NO confidence score and a CRITICAL cost impact score. Such a combination may indicate that the specification field is neither stated nor inferable from available information and that the absence of the specification field prevents, or substantially impairs, generation of a reliable cost estimate. In some embodiments, the decision algorithm may determine that a second condition is satisfied when at least two specification fields are each assigned a NO confidence score and a HIGH cost impact score. Such a combination may likewise indicate that the specification fields are neither stated nor inferable from available information and that the absence of these specification fields prevents, or substantially impairs, generation of a reliable cost estimate.

The computer-implemented method may further include an operation of displaying the one or more requests for additional information via the user interface (Block 170 in FIG. 1A). For example, in response to either the first condition or the second condition being satisfied (i.e., in response to the predetermined criteria not being satisfied), the processor may cause the system to request additional information from the user. The system may present, via the user interface 102, one or more targeted questions directed to the at least one specification field associated with the first condition and/or the at least two specification fields associated with the second condition, as shown in FIG. 1E. That is, the system may display one or more requests for additional information via the user interface 102. In some embodiments, the requested additional information may be used to update one or more specification fields and to refine the cost estimate for the construction item. As shown in FIG. 1B, the processor may generate one or more requests for additional information about the construction item in response to the combination of the confidence score and the cost impact score not satisfying the predetermined criteria (NO) at operation 172.

In some embodiments, generating, via the processor, the one or more targeted questions may include formulating at least one question that inquires about application and use case of the construction item rather than technical specifications of the construction item. In this manner, the system may enable users lacking technical expertise to provide project-related information from which one or more technical specifications may be inferred by the system. For example, instead of requesting a particular technical parameter directly, the system may present a question regarding intended use, loading conditions, project type, building function, installation environment, or other contextual information associated with the construction item. As an example, instead of directly requesting a particular technical parameter (e.g., "What PSI do you want?"), the system may generate a question such as, "What are these columns supporting?," and/or "Is this for a seismic zone?," as shown in FIG. 1E.

In some embodiments, the processor may generate and provide range-based answer options for each question. Each answer option may correspond to, or be associated with, one or more implied technical specifications usable in subsequent estimate generation or refinement. For example, a selected answer option may indicate a likely range, category, class, performance level, or other specification value associated with the construction item. In some embodiments, the answer options may be generated based on historical project data, contextual construction data, regional practices, code-related information, default assumptions, or combinations thereof. As an example, the system may generate a question such as, "How many columns? (Rough count is fine)," with range-based answer options of "Approximately 5-10 columns," "Approximately 10-20 columns," and "Approximately 20-50 columns," as shown in FIG. 1E.

In some embodiments, the processor may further generate and provide at least one industry-standard default option for a given question. The industry-standard default option may be derived from contextual information associated with the construction project, such as building type, geographic location, and application context extracted from the natural language description. For example, the default option may represent a specification value, range, or category that is typical for a construction item of the identified type in a similar project context. As an example, the system may generate a question such as, "What are these columns supporting?" with industry-standard default options of "Normal building loads – 4000 PSI," "Heavy equipment – 5000 PSI," and "Roof only – 3000 PSI," as shown in FIG. 1E. As another example, the system may generate a question such as, "Is this for a seismic zone?" with industry-standard default options of "Yes – Rebar grade 60 + increased %," and "No – Rebar grade 60 standard," as shown in FIG. 1E.

In some embodiments, the processor may generate and provide, in association with each targeted question, an explanation of cost impact indicating how a user response is expected to affect the cost estimate. For example, the explanation may indicate that different responses correspond to different estimated material costs, labor costs, equipment costs, schedule impacts, or total project costs. In this manner, the system may provide transparency regarding why the question is being asked and may assist the user in prioritizing responses. As an example, the system may generate a question such as, "Column size affects cost by 200-300% – approximate size?" to explain how a user response is expected to affect the cost estimate, as shown in FIG. 1E.

In some embodiments, the processor may prioritize presentation of the targeted questions based on corresponding cost impact scores associated with unresolved specification fields. For example, questions relating to specification fields assigned a CRITICAL cost impact score may be presented before questions relating to specification fields assigned a HIGH cost impact score. In some embodiments, the processor may further order questions within a given cost impact category based on one or more additional criteria, such as confidence score, expected estimate sensitivity, user response burden, or relevance to the current estimation state.

In some embodiments, the processor may exclude from questioning any specification field associated with a LOW cost impact score, regardless of the confidence score assigned to the specification field. As such, even when a particular specification field is absent, uncertain, or only weakly inferable, the system may refrain from generating a targeted question if variation in that specification field is unlikely to materially affect the generated cost estimate. Such operation may reduce unnecessary questioning and may improve efficiency of the estimation workflow. In some embodiments, specification fields having a MEDIUM confidence score and a HIGH or CRITICAL cost impact score may be processed differently from specification fields having a NO or LOW confidence score. For example, when a specification field is associated with a MEDIUM confidence score, the system may determine that a candidate value for that specification field is inferable with at least a threshold level of certainty from contextual information. In such embodiments, rather than generating a question requesting entirely new information, the processor may generate a confirmation question that presents an inferred cost estimate, inferred specification value, and/or other inferred project information, and requests user verification via the user interface 102.

In some embodiments, generating the one or more targeted questions for the user about the construction item may include performing, via the processor, a JavaScript Object Notation (JSON) transformation to convert one or more internally generated question structures into a format readable by the user. For example, the processor may transform one or more question objects, answer options, default options, cost-impact explanations, or related prompt data into a JSON-formatted representation that may be rendered by the user interface 102 as one or more readable questions presented to the user, as shown in FIG. 1E.

After display of the one or more targeted questions and/or confirmation questions, the system may receive, via the user interface 102, one or more responses from the user to the questions. The processor may update one or more of the specification fields based on the received responses. For example, the processor may replace a previously missing or inferred value with a user-provided value, may revise a previously extracted value, may confirm a previously inferred value, or may otherwise modify one or more stored specification fields based on the received responses. As shown in FIG. 1B, the system may receive, via the user interface 102, one or more responses to the questions at operation 174. In some embodiments, the responses may include a natural language description provided by the user and/or a user selection of an answer option, such as a range-based answer option and/or an industry-standard default option.

After updating one or more specification fields based on the user response, the processor may reassign a confidence score to the updated specification fields and may further reassign a cost impact score to the updated specification fields (Operation 152 in FIG. 1B). Reassignment of the confidence score may reflect that an updated specification field is now expressly stated, more reliably inferable, or otherwise supported to a greater degree than before receipt of the user response. Reassignment of the cost impact score may reflect updated understanding of the specification field, changes in related project attributes, changes in available estimate data, or reevaluation of projected estimate sensitivity associated with the updated specification field. The processor may then determine whether a combination of the reassigned confidence score and the reassigned cost impact score satisfies the predetermined criteria (Operation 162 in FIG. 1B). In response to determining that the combination of the reassigned confidence score and the reassigned cost impact score does not satisfy the predetermined criteria (NO), the processor may generate one or more additional requests for information about the construction item (Operation 172 in FIG. 1B) and may display the one or more additional requests for information via the user interface 102. The system may receive, via the user interface 102, one or more responses to the questions (Operation 174 in FIG. 1B).

Operations associated with application of the decision algorithm and generation of one or more requests for additional information may be performed iteratively. For example, the processor may repeat the above-described operations shown in FIG. 1B (Operations 152, 162, 172, and 174) until neither the first condition (i.e., at least one specification field has a NO confidence score and a CRITICAL cost impact score) nor the second condition (i.e., at least two specification fields each have a NO confidence score and a HIGH cost impact score) is satisfied. Put differently, the processor may repeat the above-described operations shown in FIG. 1B (Operations 152, 162, 172, and 174) until the predetermined criteria is satisfied (YES). In this manner, the system may continue to request additional information and update one or more specification fields until the available information is sufficient to proceed without further questioning under the decision logic described herein.

In some embodiments, repetition of the above-described operations shown in FIG. 1B (Operations 152, 162, 172, and 174) may be limited to a threshold number of iterations. For example, the processor may limit the repetition of these operations (or steps) to a maximum of three iterations. Likewise, in some embodiments, generation of one or more requests for additional information about the construction item may be limited to a maximum of three iterations. Such operation may reduce excessive user interaction, bound processing associated with repeated refinement attempts, and improve responsiveness of the estimation workflow.

In some embodiments, after each iteration, the processor may re-evaluate one or more specification fields based on updated user responses, reassigned confidence scores, and reassigned cost impact scores to determine whether the first condition or the second condition remains satisfied (i.e., to determine if the predetermined criteria remains unsatisfied). If neither the first condition nor the second condition is satisfied (i.e., if the predetermined criteria is satisfied), the processor may proceed with generation of a cost estimate for the construction item. If, however, the first condition or the second condition remains satisfied (i.e., if the predetermined criteria remains unsatisfied), the processor may generate one or more further requests for additional information, subject to the iteration limit. After a final permitted iteration (e.g., after a third iteration), the processor may determine whether the first condition or the second condition remains satisfied (i.e., whether the predetermined criteria remains unsatisfied). If the first condition or the second condition remains satisfied, the processor may generate a preliminary cost estimate with an uncertainty indicator reflecting one or more missing, unresolved, or insufficiently supported specification fields. The uncertainty indicator may indicate that the preliminary cost estimate is subject to uncertainty resulting from incomplete project information and may optionally identify a magnitude, category, or source of the uncertainty.

In some embodiments, additionally or alternatively, after the final permitted iteration, the processor may present, via the user interface 102, a notification identifying one or more specification fields that remain unresolved and a corresponding potential cost impact associated with the unresolved specification fields. For example, the notification may identify the unresolved specification fields, a corresponding confidence score, a corresponding cost impact score, and/or an indication that further refinement of the cost estimate may depend on receipt of additional information for that specification field. For example, the notification may be displayed together with the preliminary cost estimate. Accordingly, the system may iteratively request additional information up to a limited number of times and, if sufficient information is still unavailable after the permitted iterations, may provide a preliminary cost estimate and/or an unresolved-field notification rather than indefinitely continuing the questioning process.

The confidence-based and cost impact-based iterative refinement techniques described herein may provide technical improvements in computer-implemented construction estimation by enabling processor-controlled selective refinement of estimate inputs based on both information certainty and a projected effect of unresolved specification fields on generated cost outputs. For example, rather than uniformly generating additional questions and initiating refinement processing for all unresolved specification fields, or alternatively proceeding without regard to the significance of missing information, the system may selectively trigger user prompting, contextual retrieval, inference, and estimate-refinement operations based on a combined evaluation of confidence score and cost impact score. As a result, the system may reduce unnecessary user-interface interactions, reduce unnecessary retrieval and model-execution operations, improve responsiveness of the estimation workflow, and improve reliability of generated cost estimates, thereby improving the operation of the computer-implemented construction estimation system.

Accordingly, the system may operate in an iterative manner in which targeted questioning, confirmation of inferred information, updating of specification fields, reassignment of scores, and generation or refinement of the cost estimate are repeated until the predetermined criteria is satisfied (or until a threshold number of iterations is reached). Such operation may enable the system to progressively refine estimate inputs while limiting user interaction to questions and confirmations that are justified by a corresponding degree of uncertainty and projected cost impact.

The computer-implemented method may further include an operation of generating, via the processor, a cost estimate for the construction item based on the at least one specification field in response to the combination of the confidence score and the cost impact score satisfying the predetermined criteria (Block 180 in FIG. 1A). For example, in response to determining that the combination of the reassigned confidence score and the reassigned cost impact score satisfies the predetermined criteria (YES) (Operation 162 in FIG. 1B), the processor may generate a cost estimate for the construction item based on the updated specification field(s).

In some embodiments, in response to determining that neither the first condition nor the second condition is satisfied (i.e., in response to determining that the predetermined criteria is satisfied), the processor may apply one or more intelligent defaults (e.g., derived from construction context data) for any specification field having a confidence score below HIGH and may generate a cost estimate for the construction item based on the specification fields. The generated cost estimate may then be presented to the user via the user interface 102.

In some embodiments, applying the intelligent defaults may include retrieving contextual data corresponding to the specification fields. Put differently, generating the cost estimate for the construction item may include retrieving contextual data for the specification fields. The contextual data may include, for example, industry-standard default specifications associated with a construction item type and building classification, regional building code requirements for a geographic location associated with the construction project, historical project data from similar construction projects, and/or current material costs and labor rates for the geographic region associated with the construction project. In some embodiments, the regional building code requirements may include seismic zone requirements, climate-related considerations, local code amendments, or combinations thereof. In some embodiments, current material costs and labor rates may be retrieved from a pricing database updated at intervals of about 24 hours or less, although it will be appreciated that other intervals may be used. In some embodiments, the historical project data may include specification patterns and actual costs for comparable items.

In some embodiments, the processor may augment the specification fields with current market data during generation of the cost estimate. For example, the processor may supplement the specification fields using one or more of material cost information updated on a daily basis, labor rates adjusted according to union contract cycles and/or prevailing wage requirements for the geographic region, building code requirements updated on an annual basis, and equipment costs adjusted according to current fuel prices and/or equipment availability. In this manner, the cost estimate may reflect both the resolved specification fields and current market conditions associated with the construction project.

In some embodiments, generating the cost estimate may include accessing, via the processor, one or more databases storing contextual data and/or current market data associated with the construction item (Operation 182 in FIG. 1B). For example, the processor may generate one or more database queries based on the specification fields, a construction item classification, and/or project context associated with the construction project. In some embodiments, the processor may narrow a search space using a hierarchical construction classification (e.g., a CSI code hierarchy), perform semantic retrieval using vector representations of item descriptions, and execute ranked structured queries configured to prioritize exact matches, partial matches, and related-item matches. The processor may store query results for frequently occurring combinations of specification fields in a cache so that subsequent requests associated with the same or similar combinations may be satisfied without repeated querying of the database. Retrieved data may include, for example, industry-standard default specifications, regional building code requirements, historical project data, and/or current material costs and labor rates, and the processor may use the retrieved data to supplement and/or refine the specification fields and generate the cost estimate.

In some embodiments, in response to determining that neither the first condition nor the second condition is satisfied (i.e., in response to determining that the predetermined criteria is satisfied), the processor may generate a plurality of candidate specification sets for the construction item (Operation 184 in FIG. 1B). For example, the processor may generate a standard specification set, an economy specification set, and a heavy-duty specification set for the construction item.

As shown in FIG. 1F, the standard specification set may include industry-standard default cost values for each specification field based on, for example, construction context, building type, and geographic location. As shown in FIG. 1G, the economy specification set may include specification cost values reduced relative to the standard specification set (e.g., reduced by about 20% or more), and may include, for example, reduced material strength ratings, reduced dimensions, reduced reinforcement percentages, or combinations thereof. As shown in FIG. 1H, the heavy-duty specification set may include specification cost values increased relative to the standard specification set (e.g., increased by about 20% or more), and may include, for example, increased material strength ratings, increased dimensions, increased reinforcement percentages, or combinations thereof.

In some embodiments, the processor may apply one or more context-aware constraint rules to the economy specification set to prevent or mitigate one or more specification values from falling below minimum allowable thresholds (e.g., below minimum cost thresholds). The constraint rules may be based, for example, on applicable building codes for the geographic location, safety requirements associated with an application context, and/or structural requirements associated with the building type and intended load. For example, the constraint rules may prevent or mitigate reduction of material strength below a minimum level required for chemical exposure environments, reduction of reinforcement below a minimum level required for vibration-prone applications, and/or reduction of dimensions or other structural characteristics below thresholds required for a selected building type or loading condition.

The computer-implemented method may further include an operation of displaying the cost estimate via the user interface (Block 190 in FIG. 1A). In some embodiments, the processor may generate a first cost estimate based on the standard specification set, a second cost estimate based on the economy specification set, and a third cost estimate based on the heavy-duty specification set (Operation 192 in FIG. 1B). The processor may then present the first, second, and third cost estimates to the user in the user interface 102 with a comparison indicating specification differences and cost variance between the options.

For example, the processor may display the three cost estimates in a comparative format showing relative cost differences between the options. For each specification field that differs among the specification sets, the processor may display corresponding specification values and may provide an indication of the cost impact associated with the difference. In some embodiments, the processor may further highlight any specification fields in the economy specification set that were constrained by the context-aware constraint rules and may display corresponding minimum allowable values. In some embodiments, the processor may provide, together with the presented cost estimates, a selection interface enabling the user to select one of the three options, or to customize one or more specification values within one or more displayed ranges. For example, the user may select the first cost estimate based on the standard specification set, the second cost estimate based on the economy specification set, or the third cost estimate based on the heavy-duty specification set as a basis for further refinement, or may modify one or more individual specification values responsive to the displayed comparison.

In some embodiments, generating the cost estimate for the construction item may include performing, via the processor, a JSON transformation to convert one or more internally generated estimate values into a structured output format readable by the user. For example, the processor may transform one or more cost-estimate data structures, line-item values, specification values, confidence indicators, or related estimate information into a JSON-formatted representation that may be rendered by the user interface 102 in a human-readable format. In this manner, the system may convert machine-processed estimation data into output suitable for display to the user.

The processor may store the generated cost estimates and associated specification fields in a project database. The processor may subsequently receive actual cost data for the construction item from the completed construction project and may compare the actual cost data to the generated cost estimate to determine an estimation variance. In some embodiments, the processor may analyze the estimation variance to identify one or more specification fields contributing to the variance. For example, the processor may determine whether inaccuracies in one or more default values, inferred values, confidence assignments, cost impact assignments, or market adjustments contributed to a difference between the generated cost estimate and the actual cost data.

Based on the analysis of the estimation variance, the processor may adjust one or more intelligent default values and/or one or more confidence scoring parameters to improve accuracy of future cost estimates. For example, the processor may revise a context-derived default specification value, modify one or more thresholds used in confidence-score assignment, update one or more weighting parameters associated with cost-impact analysis, or otherwise modify one or more estimation parameters based on completed project outcomes. In this manner, the system may learn from completed projects and may iteratively improve performance of subsequent cost-estimation operations.

In some embodiments, the processor may perform the above-described operations shown in FIGS. 1A and 1B for a plurality of construction items associated with the construction project to generate a project-level cost estimate. For example, the processor may receive, via the user interface 102, respective natural language descriptions for each of the plurality of construction items. Each natural language description may correspond to a respective construction item associated with the construction project. For each construction item, the processor may extract one or more specification fields, assign corresponding confidence scores and cost impact scores, selectively request additional information or apply one or more intelligent defaults, and generate an individual cost estimate for the construction item. As such, the iterative refinement process described herein may be performed independently for each of a plurality of construction items so that unresolved, uncertain, or cost-sensitive specification fields may be refined on an item-by-item basis.

After generating individual cost estimates for the plurality of construction items, the processor may aggregate the individual cost estimates to generate a total project cost estimate. For example, the processor may sum, combine, or otherwise aggregate costs associated with structural items, foundation items, concrete items, reinforcement items, finishing items, equipment-related items, and/or other construction items associated with the construction project.

In some embodiments, the processor may further identify dependencies between construction items and may sequence the construction items according to construction logic. For example, the processor may determine that one construction item is to be estimated, scheduled, or contextualized in relation to another construction item based on structural dependency, installation order, project phase, trade sequence, site conditions, or other project relationships. The sequencing may be used, for example, to improve organization of the project estimate, to identify related cost impacts across items, and/or to support downstream scheduling or project-planning operations.

The processor may present, via the user interface 102, the total project cost estimate together with a breakdown by construction item. The breakdown may include individual cost estimates for respective construction items and may further include one or more confidence indicators for each construction item based on the confidence scores associated with the underlying specification fields for the construction item. For example, a construction item associated with a greater number of highly confident specification fields may be presented with a higher confidence indicator than a construction item associated with one or more unresolved or inferred specification fields. In this manner, the user may view both an overall project estimate and item-level estimate, together with an indication of relative certainty across the plurality of construction items.

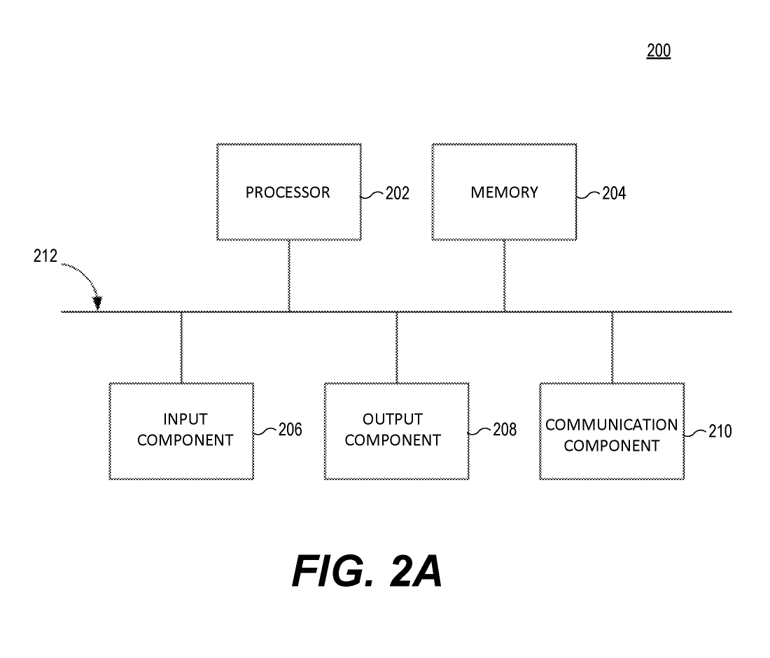

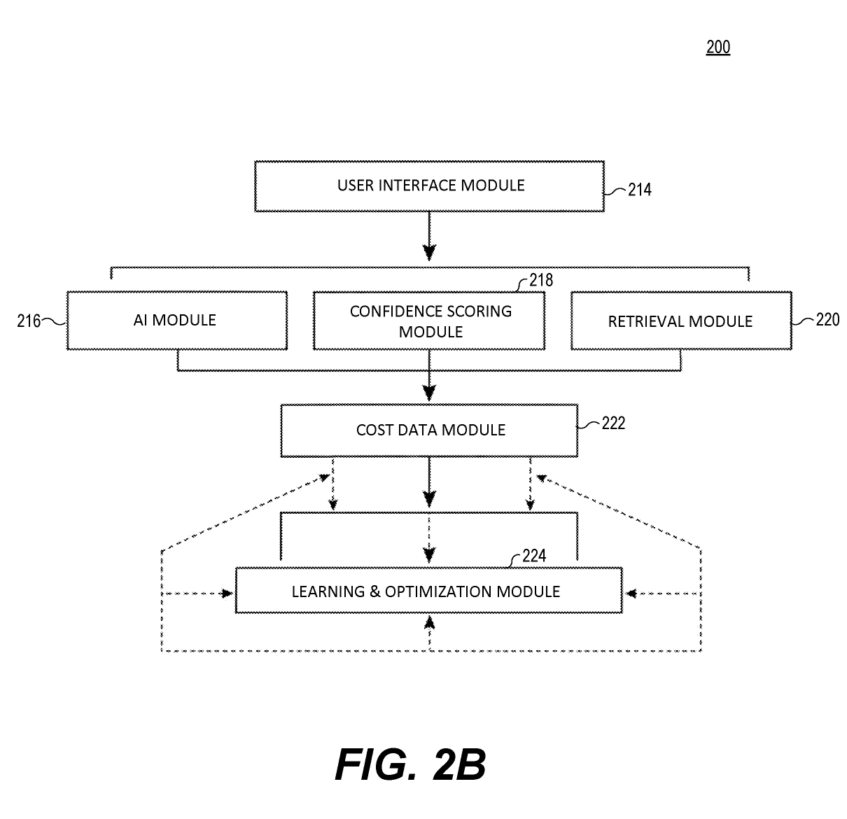

FIGS. 2A and 2B are schematic block diagrams illustrating example computing systems for generating construction cost estimates, according to some embodiments of the present disclosure.

As shown in FIG. 2A, the system 200 may include a processor 202, a memory component 204, an input component 206, an output component 208, and a communication component 210 operatively coupled to one another via a bus 212. The processor 202 may be configured to execute computer-readable instructions stored in the memory 204 to perform one or more operations described herein. It will be appreciated that the processor 202 may include one or more processors, and thus the term "processor" as used herein may refer to a single processor or to multiple processors. The memory 204 may store program instructions, configuration data, project data, cost data, specification data, and/or other information used by the system 200. The input component 206 may be configured to receive user inputs and/or other input data, such as, for example, natural language descriptions, user selections, project attributes, or other construction-related information. The output component 208 may be configured to provide one or more outputs, such as cost estimates, questions, notifications, comparisons, confidence indicators, or other information associated with the construction estimation operations described herein. In some embodiments, the input component 206 and/or the output component 208 may include the user interface 102 described above. For example, the user interface 102 may be coupled to the processor 202 and may be configured to receive to receive natural language descriptions from a user and present (i.e., display) cost estimates and questions to the user. The communication component 210 may be configured to communicate with one or more systems, databases, client devices, servers, and/or networks. The bus 212 may provide one or more communication paths (e.g., wired and/or wireless) between the processor 202, the memory 204, the input component 206, the output component 208, and the communication component 210.

As shown in FIG. 2B, the system 200 may include a plurality of modules configured to cooperate in generating, refining, and presenting cost estimates for construction items associated with construction projects. For example, the system 200 may include a user interface module 214, an AI module 216, a confidence scoring module 218, a retrieval module 220, a cost data module 222, and a learning and optimization module 224. It will be understood that the illustrated modules in FIG. 2B are provided by way of example only, and that functions described with respect to one module may be distributed across multiple components, combined, omitted, or otherwise arranged in different manners in various embodiments. In some embodiments, one or more of the modules described herein may be implemented using one or more corresponding interfaces, databases, engines, or other system components.

The user interface module 214 may be configured to receive user inputs and present outputs associated with one or more estimation operations. In some embodiments, the user interface module 214 may be implemented as a web application or other software interface through which a user may provide a natural language description of a construction item associated with a construction project. The user interface module 214 may further present one or more targeted questions, answer options, default options, cost estimates, specification sets, comparison information, notifications, confidence indicators, and/or other estimation-related outputs to the user. For example, the user interface module 214 may include, or may be implemented using, the user interface 102 described above that is configured to receive natural language descriptions from a user and to present one or more targeted questions, answer options, default options, cost estimates, specification sets, comparison information, notifications, confidence indicators, and/or other estimation-related outputs to the user.

The AI module 216 may be configured to process natural language inputs and generate structured outputs for use in estimate generation and refinement. For example, the AI module 216 may include one or more prompt-based workflows and/or model-driven routines configured to perform input analysis, question generation, specification building, and/or item selection. The AI module 216 may analyze a natural language description to extract one or more specification fields, generate one or more targeted questions for unresolved or uncertain specification fields, generate or refine structured specification data, and identify one or more candidate construction items, classifications, or assemblies associated with the received input. In some embodiments, the AI module 216 may include a language model interface configured to communicate with an AI language model. The language model interface may provide the received natural language description and one or more structured prompts to the AI language model and may receive, from the AI language model, structured output identifying one or more extracted specification fields and, in some embodiments, corresponding assigned confidence scores and/or cost impact scores. The language model interface may be coupled to the processor 202.

The confidence scoring module 218 may be configured to assign and evaluate confidence scores and/or cost impact scores associated with one or more specification fields. For example, the confidence scoring module 218 may determine whether a given specification field is expressly stated, inferable from context, weakly inferable, or absent from the available input, and may assign a corresponding confidence score (e.g., HIGH, MEDIUM, LOW, or NO). The confidence scoring module 218 may further determine a projected effect of the specification field on generated cost output and may assign a corresponding cost impact score (e.g., CRITICAL, HIGH, MEDIUM, or LOW). In some embodiments, the confidence scoring module 218 may apply one or more decision rules (or a decision algorithm) to determine whether additional questioning, contextual retrieval, inference, or estimate refinement should be performed. For example, the confidence scoring module 218 may use output received via the language model interface and/or information retrieved by the retrieval module 220 in assigning the confidence scores and the cost impact scores.

The retrieval module 220 may be configured to retrieve contextual information relevant to the construction item and the construction project. The retrieval module 220 may access a vector database, document index, or other searchable data repository storing construction-related context data. For example, the retrieval module 220 may access one or more searchable data repositories, including a specification database storing construction specification codes, material specifications, dimension standards, and/or other construction-related specification data organized according to construction item classification. The specification database may be coupled to the processor 202. In some embodiments, the retrieval module 220 may retrieve information associated with construction classification data, including, for example, CSI codes, historical project records, regional pricing information, code-related information, and/or other contextual records relevant to extraction, inference, or estimate generation. For example, the retrieval module 220 may perform retrieval-augmented generation (RAG) operations by providing retrieved contextual information to the AI module 216 for use in inferring or refining one or more specification fields.

The cost data module 222 may be configured to store and provide cost-related information usable in generating one or more cost estimates for the construction item. In some embodiments, the cost data module 222 may include one or more relational databases, such as, for example, a structured query language (SQL) database, storing construction cost data. For example, the cost data module 222 may include, or may communicate with, a pricing database storing current material costs, labor rates, equipment costs, regional adjustments, productivity values, historical pricing records, and/or other cost-related information. In some embodiments, the pricing database may organize current material costs and labor rates according to geographic region and may be updated at intervals of about 24 hours or less, although it will be appreciated that other intervals may be used. The pricing database may be coupled to the processor 202. In some embodiments, the cost data module 222 may be queried using one or more dynamic filters based on a construction item type, geographic location, specification values, project classification, or other project-related attributes.

The learning and optimization module 224 may be configured to improve operation of the system 200 over time based on prior estimation sessions and project outcomes. For example, the learning and optimization module 224 may include one or more machine learning models, such as one or more neural networks, configured to adjust default specification values, refine confidence-scoring parameters, improve inference of missing specification fields, and/or improve cost-estimate generation based on historical project outcomes. In some embodiments, the learning and optimization module 224 may compare generated cost estimates to actual project costs and may update one or more internal parameters or defaults in response to identified estimation variance.

In some embodiments, a natural language description received through the user interface module 214 may be provided to the AI module 216 for processing and generation of structured outputs, including one or more specification fields associated with the construction item. The retrieval module 220 may retrieve contextual information relevant to the construction item and the construction project, and the confidence scoring module 218 may assign and evaluate confidence scores and/or cost impact scores associated with the specification fields to determine whether additional clarification, contextual retrieval, inference, or estimate refinement is to be performed. The cost data module 222 may provide cost-related information corresponding to identified or inferred project parameters for generation of a cost estimate, and the learning and optimization module 224 may update one or more internal models, confidence-scoring parameters, and/or default values based on the estimation operation and any resulting project outcome data.

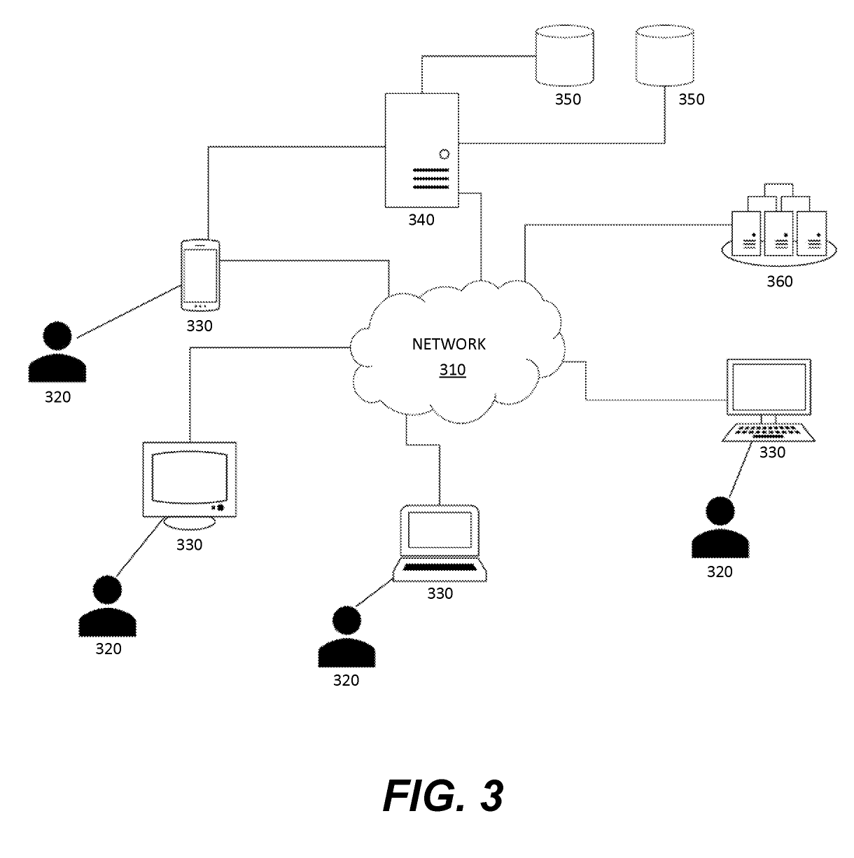

FIG. 3 is a schematic diagram illustrating an example network useable to facilitate a computer-implemented method for generating a cost estimate for a construction item associated with a construction project, according to some embodiments of the present disclosure.

As shown in FIG. 3, a network 310 may provide communication (i.e., communicative connection) among various different user devices 330 and/or to and from users 320 thereof. For example, the network 310 may be or may include the Internet or another TCP/IP protocol network such as a wide area network (WAN), local area network (LAN), intranet, and/or a cloud-based or cloud computing network or platform. In some embodiments, the network 310 may be one or more wireless networks each of which implements one or more networking protocols and/or standards, such as Code Division Multiple Access (CDMA), Global System for Mobile Communications (GSM), Long-Term Evolution (LTE), 802.11 standards (Wi-Fi), Bluetooth, Near Field Communications (NFC), etc. The network 310 may enable meaningful communication between devices 330 and/or other information sources. For example, the users 320 may be contractor personnel, estimators, project managers, engineers, architects, owners, or other entities.

In some embodiments, one or more providers 360 may connect to one or more user devices 330, either directly or via the network 310 or another network. Providers 360 may be any content, media, functionality, software, and/or operations providers for the user devices 330. Providers 360 may include a network operator, such as a cellphone and mobile data carrier operating network, and may control access rights of user devices 330 as well as general operation of the network 310. Providers 360 may be a website or ftp server offering downloadable files or other content that may be displayed or otherwise consumed through user devices 330. Although providers 360 are shown around the network 310 for connectivity to the user devices 330, it will be understood that there may be any direct or indirect connection between any provider 360 and any user device 330.

The user device 330 may be any electronic device, such as a mobile device, capable of performing one or more software-enabled operations, including accepting input from users 320 or from another electronic device and operating based on the input. Examples of user devices 330 may include (but are not limited to) smartphones, tablets, desktop computers, laptop computers, and the like.

In some embodiments, a user device 330 may be controlled by a user 320 thereof to access an online platform or system via the network 310. For example, the user device 330 may be configured to communicate with a remote device 340 (e.g., via the network 310), which may be configured to provide content, data, instructions, or the like to the user device 330. For example, the user device 330 may transmit a request for data to the remote device 340, and the remote device 340 may respond with the data. Such content, data, instructions, or the like may be provided, for example, by databases 350 communicatively coupled to the remote device 340. The remote device 340 may also be configured to receive content, data, instructions or the like from the user device 330. Such content, data, instructions, or the like may be communicated responsive to a request transmitted from the remote device 340 (e.g., the remote device 340 may poll the user device 330), or may be communicated absent a remote device request.

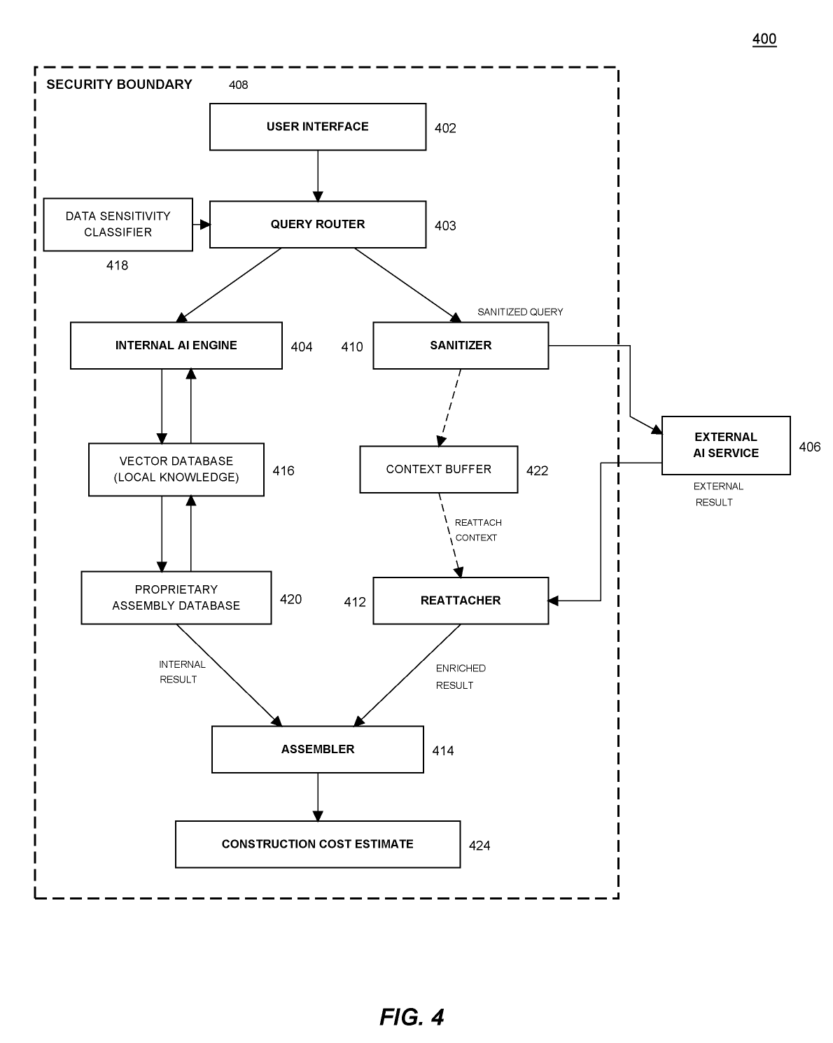

FIG. 4 is a schematic block diagram illustrating an example hybrid artificial intelligence architecture with a query router and security boundary for construction cost estimation, according to some embodiments of the present disclosure.

Referring to FIG. 4, the system may include a hybrid artificial intelligence (AI) architecture 400 (which may also be referred to as a hybrid AI system) with a query router 403 and a security boundary 408 for construction cost estimation. In some embodiments, the query router 403 of the hybrid AI system 400 may operate within the security boundary 408 of a computing environment. For example, the query router 403 may receive input via a user interface 402. The query router 403 may decompose construction cost estimation into a plurality of estimation subtasks. For each subtask, the query router 403 may determine whether to process it via an internal artificial intelligence (AI) engine 404 operating entirely within the security boundary 408 or via an external artificial intelligence (AI) service 406 operating outside the security boundary 408. The determination may be based on a data sensitivity classification assigned to data required by the estimation subtask. For example, a data sensitivity classifier 418 may assign a data sensitivity classification to data. The internal AI engine 404 may include locally-deployed machine learning models, a retrieval-augmented generation (RAG) system with a vector database 416 of construction knowledge, and computational cost models, all executing within the security boundary 408 without transmitting project data externally. In some embodiments, approximately forty percent (40%) of subtasks may require private content and may be processed internally, twenty percent (20%) may be sensitive but may need external reasoning and may be processed using a sanitize-send-reattach pattern, and forty percent (40%) may be generic calculations and may be sent externally.

The query router 403 may decompose estimation into subtasks and dynamically route each subtask to the internal AI engine 404 operating within the security boundary 408 or to the external AI service 406 based on the data sensitivity classification assigned by the data sensitivity classifier 418. The subtask results may be assembled, within the security boundary 408, by an assembler 414 to generate the construction cost estimate 424. In some embodiments, the construction cost estimate 424 may be presented to a user via the user interface 402.

The query router 403 may evaluate four criteria for each estimation subtask to determine optimal routing. For example, these criteria may include: (1) data sensitivity classification assigned to the data required by the subtask; (2) whether the subtask requires access to private content stored within the security boundary 408; (3) a task complexity score indicating the reasoning capability required; and (4) a cost optimization factor indicating the relative cost of processing the subtask internally versus externally. In some embodiments, subtasks may be assigned to internal processing within the security boundary 408 when they reference sensitive data (e.g., to maintain data privacy), require private content, can be resolved by local knowledge base lookup, or when internal processing is more cost-effective. In some embodiments, subtasks may be assigned to external processing outside the security boundary 408 only when they contain no sensitive data, require no private content, and benefit from external reasoning capabilities.

Project data in the hybrid AI system 400 may be classified into four sensitivity tiers, each with specific handling requirements. For example, Tier 1, designated Vault data, may never be transmitted externally and may include client identity, project addresses, financial terms, proprietary pricing, and/or competitive intelligence. Tier 2, designated Sharded data, may be fragmented across multiple independent stateless requests so that no single request reveals the complete project. Tier 3, designated Anonymized data, may be transmitted with identifying information removed and replaced with generic references. Tier 4, designated Reference data, may include generic industry knowledge queries containing no client-specific or proprietary information. In some embodiments, the classification is configurable by a client administrator who may promote any data element to a higher sensitivity tier based on organizational security policies.

For estimation subtasks requiring both private context and external artificial intelligence reasoning, the system 400 may employ a sanitize-send-reattach pattern. For example, the sanitize-send-reattach-pattern may be performed at least in part by a sanitizer 410 and a reattacher 412. In some embodiments, the system 400 may: (a) identify data element classified at or above a predetermined sensitivity threshold; (b) remove them from the query and store the data in a context buffer 422 within the security boundary 408; (c) replace the removed data with generic placeholders to produce a sanitized query; (d) transmit the sanitized query to the external AI service 406; (e) receive the result from the external AI service 406; (f) map the external result back to the context buffer 422; and (g) reattach the private data within the security boundary 408. This pattern may enable use of external AI reasoning while maintaining complete data security (e.g., for data privacy).

The internal AI engine 404 may maintain private content within the security boundary 408 that is never transmitted to external AI services 406. In some embodiments, this private content may include: one or more proprietary assembly databases 420 including, for example, construction assembly definitions, material specifications, labor requirements, and cost relationships; client-specific engineering rules including construction standards, material preferences, and quality requirements; regional engineering rules including local building code interpretations, inspector preferences, and permitting requirements; and/or historical bid intelligence including aggregated patterns from past bids, contractor performance data, and market trends.

In some embodiments, a vault-only processing mode may be activated in which all estimation subtasks are processed by the internal AI engine 404 with zero external transmissions. This mode may be selectable on a per-project basis, enabling the same platform to process some projects in hybrid mode for speed and cost efficiency and other projects in vault-only mode for maximum security based on project sensitivity classification. The security posture of the system 400 may thus be customizable to match organizational risk requirements.

In some embodiments, the internal AI engine 404 may include a domain specialist model created by fine-tuning a base large language model on a construction-domain training corpus using parameter-efficient fine-tuning techniques. The training corpus may include construction curriculum materials, specification documents, assembly definitions, historical cost estimates, and/or building code documents. The fine-tuned domain specialist model may process subtasks requiring construction-specific knowledge including specification code interpretation, assembly selection, and material compatibility analysis, thereby improving accuracy compared to general-purpose language models.

In some embodiments, the system 400 may employ continuous learning to improve estimation accuracy over time. For example, the system 400 may receive actual project outcome data after project completion and compare it against the generated cost estimates to identify estimation variances. Systematic biases may be identified through statistical analysis. The identified biases may be used to update assembly database cost relationships, regional cost adjustment factors, confidence scoring models, and the domain knowledge base. This feedback loop may continuously improve system performance.

In some embodiments, a security configuration interface may enable a client administrator to exercise fine-grained control over system security posture. The interface may allow selection of a processing mode (e.g., vault-only, hybrid, or full-external), customization of sensitivity tier assignments for specific data types, and access to an audit trail recording which subtasks were processed internally versus externally. This transparency and configurability may enable enterprise clients to maintain full visibility and control over data handling.

Unless otherwise defined, all terms used herein have the same meaning as commonly understood by one of ordinary skill in the art. Further, all terms should be interpreted as having a meaning that is consistent with their meaning in the context of the relevant art and this disclosure and will not be interpreted in an idealized or overly formal sense unless expressly so defined herein.

The terminology used herein is for the purpose of describing particular embodiments only and is not intended to be limiting of embodiments. The singular forms "a," "an," and "the" are intended to include the plural forms as well, unless the context clearly indicates otherwise. The terms "comprises," "comprising," "includes" and/or "including" specify the presence of the stated features, steps, operations, elements, components and/or groups, but do not preclude the presence or addition of one or more other features, steps, operations, elements, components and/or groups thereof.

It will be understood that, although the terms "first," "second," etc. may be used throughout this specification to describe various elements, these elements should not be limited by these terms. Rather, these terms are only used to distinguish one element from another. For example, a first element could be termed a second element, and, similarly, a second element could be termed a first element, without departing from the scope of the present disclosure. As used herein, the term "and/or" includes any and all combinations of one or more of the associated listed items.

It will be understood that when an element is referred to as being "connected" or "coupled" to another element, it can be directly connected or coupled to the other element or intervening elements may be present. In contrast, when an element is referred to as being "directly connected" or "directly coupled" to another element, there are no intervening elements present. The term "connected" may include physical and/or electrical connections.

Example embodiments are described herein with reference to the accompanying drawings, which may include diagrams that are schematic illustrations of idealized embodiments. Many different forms and embodiments are possible without deviating from the teachings of this disclosure. Accordingly, the present disclosure should not be construed as limited to the example embodiments set forth herein. As such, it will be understood by those of ordinary skill in the art that various changes in form and details may be made therein without departing from the scope as defined herein. Embodiments of the present disclosure are also described with reference to flowchart diagrams. It will be appreciated that the steps shown in the flowchart diagrams need not be performed in the order shown.

The example embodiments are mainly described in terms of particular methods and systems provided in particular implementations. However, the methods and systems may operate effectively in other implementations. The embodiments may be described with respect to systems and/or devices having certain components. However, the systems and/or devices may include fewer or additional components than those shown, and variations in the arrangement and type of the components may be made without departing from the scope of the present disclosure.

The example embodiments are also described in the context of particular methods having certain steps or operations. However, the methods may operate effectively for other methods having different and/or additional steps/operations and steps/operations in different orders that are not inconsistent with the example embodiments. Thus, the present disclosure is not intended to be limited to the example embodiments shown, but rather is to be accorded the widest scope consistent with the principles and features described herein.

Aspects of the present disclosure may be implemented entirely in hardware, entirely in software (including firmware, resident software, microcode, etc.), or in a combination of software and hardware, all of which may generally be referred to herein as a "circuit," "module," "component," "system," or "platform." Furthermore, aspects of the present disclosure may take the form of a computer program product embodied in one or more computer-readable media having computer-readable program code embodied thereon. In some embodiments, the computer program product may include a non-transitory computer-readable medium storing instructions that, when executed by one or more processors, cause the one or more processors to perform one or more operations described herein.

Aspects of the present disclosure may be described herein with reference to flowchart illustrations and/or block diagrams of methods and systems according to example embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer, special purpose computer, or other programmable data processing apparatus to produce a machine, such that the instructions, which execute via the processor of the computer or other programmable instruction execution apparatus, create a mechanism for implementing the operations/steps specified in the flowchart illustrations and/or block diagrams. As used herein, "a processor" may refer to one or more processors.

The flowcharts and block diagrams in the figures illustrate the architecture, functionality, and operation of possible implementations of systems and methods according to various aspects of the present disclosure. In this regard, each block in the flowcharts or block diagrams may represent a module, segment, or portion of code, which includes one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. Although some of the diagrams may include arrows on communication paths to show a primary direction of communication, it will be understood that communication may also occur in the opposite direction to the depicted arrows. It will also be noted that each block of the block diagrams and/or flowcharts, and combinations of blocks in the block diagrams and/or flowcharts, may be implemented by special purpose hardware-based systems that perform the specified functions or acts, or combinations of special purpose hardware and computer instructions.

The above-disclosed subject matter is to be considered illustrative, and not restrictive, and the appended claims are intended to cover all such modifications, enhancements, and other embodiments, which fall within the scope of the present disclosure. Although specific terms may be employed, they are used in a generic and descriptive sense only and not for purposes of limitation. Thus, to the maximum extent allowed by law, the scope is to be determined by the broadest permissible interpretation of the following claims and their equivalents, and shall not be restricted or limited by the foregoing detailed description.

What is claimed is:

1. A computer-implemented method for generating a cost estimate for a construction item associated with a construction project, the method comprising:
(a) receiving, via a user interface, a natural language description of the construction item from a user;
(b) extracting, via a processor, a plurality of specification fields from the received natural language description, wherein each of the plurality of specification fields includes one or more of: a quantity, a material type, a dimension, a quality specification, and an application context of the construction item;
(c) for each of the plurality of specification fields, assigning, via the processor:
(i) a confidence score selected from: a HIGH confidence score indicating that there is no ambiguity in information contained in the plurality of specification fields, a MEDIUM confidence score indicating that information in the plurality of specification fields can be inferred from the received natural language description, a LOW confidence score indicating that there is uncertainty about the information contained in the plurality of specification fields, or a NO confidence score indicating that there is insufficient information in the plurality of specification fields; and
(ii) a cost impact score selected from: a CRITICAL cost impact score indicating that a cost for the construction item cannot be obtained from information contained in the plurality of specification fields, a HIGH cost impact score indicating that a cost for the construction item may vary by 20% or more based on the information contained in the plurality of specification fields, a MEDIUM cost impact score indicating that a cost for the construction item may vary by 10% - 20% based on the information contained in the plurality of specification fields, or a LOW cost impact score indicating that a cost for the construction item may vary by less than 10% based on the information contained in the plurality of specification fields;
(d) applying a decision algorithm, via the processor, to determine whether to request additional information from the user, wherein the decision algorithm comprises:
(i) determining a first condition is satisfied when at least one specification field has a confidence score of NO and a cost impact score of CRITICAL; and
(ii) determining a second condition is satisfied when at least two specification fields each have a confidence score of NO and a cost impact score of HIGH;
(e) in response to either the first condition or the second condition being satisfied:
(i) generating, via the processor, one or more targeted questions directed to ones of the plurality of specification fields having a confidence score of NO or LOW and a cost impact score of CRITICAL or HIGH;
(ii) presenting, via the processor, the one or more questions to the user via a display;
(iii) receiving, via the processor, user responses to the one or more questions;
(iv) updating, via the processor, the plurality of specification fields based on the user responses;
(v) reassigning, via the processor, confidence scores and cost impact scores for the updated specification fields; and
(vi) repeating steps (d) through (e) until neither the first condition nor the second condition is satisfied;
(f) in response to neither the first condition nor the second condition being satisfied:
(i) applying, via the processor, intelligent defaults derived from construction context data for any specification field having a confidence score below HIGH; and
(ii) generating, via the processor, a cost estimate for the construction item based on the plurality of specification fields and presenting the cost estimate to the user.

2. The method of claim 1, wherein generating, via the processor, the one or more targeted questions comprises:
formulating at least one question that inquires about application and use case rather than technical specifications, thereby enabling users without technical expertise to provide information from which technical specifications can be inferred;
providing range-based answer options for each question, wherein each answer option is associated with implied technical specifications;
providing at least one industry-standard default option derived from contextual information including building type, geographic location, and application context extracted from the natural language description;
including an explanation of cost impact for each question, indicating how the user's response will affect the cost estimate; and
prioritizing the one or more questions based on cost impact score, such that questions relating to CRITICAL cost impact fields are presented before questions relating to HIGH cost impact fields.

3. The method of claim 1, wherein repeating steps (d) through (e) is limited to a maximum of three iterations, and wherein after a third iteration:
if the first condition or second condition remains satisfied, generating, via the processor, a preliminary cost estimate with an uncertainty indicator reflecting the missing specification fields; or
presenting, via the processor, a notification to the user identifying the specification fields that remain unresolved and their potential cost impact.

4. The method of claim 1, wherein generating the one or more targeted questions comprises:
evaluating each specification field to identify fields where the confidence score is NO or LOW and the cost impact score is CRITICAL or HIGH;
excluding from questioning any specification field where the cost impact score is LOW, regardless of confidence score; and
for specification fields having a MEDIUM confidence score and HIGH or CRITICAL cost impact score, generating a confirmation question presenting an inferred cost estimate and requesting user verification.

5. The method of claim 1, wherein, in response to neither the first condition nor the second condition being satisfied, the method further comprises:
generating, via the processor, a standard specification set for the construction item, wherein the standard specification set comprises industry-standard default cost values for each specification field based on the construction context, building type, and geographic location;
generating, via the processor, an economy specification set for the construction item, wherein the economy specification set comprises specification cost values reduced by approximately 20% from the standard specification set, including one or more of: reduced material strength ratings, reduced dimensions, and reduced reinforcement percentages;
generating, via the processor, a heavy-duty specification set for the construction item, wherein the heavy-duty specification set comprises specification cost values increased by approximately 20% from the standard specification set, including one or more of: increased material strength ratings, increased dimensions, and increased reinforcement percentages;
applying context-aware constraint rules, via the processor, to the economy specification set to prevent specification values from falling below minimum cost thresholds required by:
applicable building codes for the geographic location;
safety requirements based on the application context, including minimum material strength for chemical exposure environments and minimum reinforcement for vibration-prone applications; and
structural requirements based on the building type and intended load;
generating, via the processor, a first cost estimate based on the standard specification set;
generating, via the processor, a second cost estimate based on the economy specification set;
generating, via the processor, a third cost estimate based on the heavy-duty specification set; and
presenting, via the processor, the first, second, and third cost estimates to the user with a comparison indicating the specification differences and cost variance between each option.

6. The method of claim 1, wherein applying intelligent defaults comprises retrieving, via the processor, contextual data for the plurality of specification fields, the contextual data comprising one or more of:
industry-standard default specifications associated with the construction item type and building classification;
regional building code requirements for the geographic location associated with the construction project, including seismic zone requirements, climate considerations, and local amendments;
historical project data from similar construction projects, including specification patterns and actual costs for comparable items; and
current material costs and labor rates for the geographic region associated with the construction project, retrieved from a pricing database updated at intervals of 24 hours or less.

7. The method of claim 1, wherein generating the cost estimate comprises augmenting the specification fields, via the processor, with current market data including one or more of:
material cost information updated on a daily basis;
labor rates adjusted according to union contract cycles and prevailing wage requirements for the geographic region;
building code requirements updated on an annual basis; and
equipment costs adjusted based on current fuel prices and equipment availability.

8. The method of claim 1, wherein extracting the plurality of specification fields and assigning the confidence scores and cost impact scores comprises:
providing the natural language description to an artificial intelligence language model;
providing the language model with a structured prompt comprising:
instructions to extract specification fields from the natural language description;
definitions of the confidence score levels and criteria for assignment;
definitions of the cost impact score levels and criteria for assignment; and
construction context data including the building type, geographic location, and project classification;
receiving from the language model a structured output comprising the extracted specification fields with assigned confidence scores and cost impact scores; and
parsing the structured output to populate a specification data structure for subsequent processing.

9. The method of claim 8, wherein providing construction context data to the language model comprises a retrieval-augmented generation process comprising:
identifying, via the processor, specification fields having a MEDIUM confidence score;
for each identified specification field, querying, via the processor, a vector database to retrieve contextual documents relevant to the specification field, the construction item type, and the building context;
injecting, via the processor, the retrieved contextual documents into the structured prompt provided to the language model; and
instructing, via the processor, the language model to infer specification values for the identified specification fields based on the retrieved contextual documents.

10. The method of claim 9, wherein the vector database comprises:
a plurality of construction specification codes organized according to a hierarchical classification system comprising divisions, subdivisions, and sections;
specification patterns associated with building types, including typical material specifications, dimension ranges, and quality requirements for each building classification;
regional construction data comprising building code requirements, climate considerations, and material availability by geographic region; and
historical project data comprising specifications and actual costs from completed construction projects, indexed by project type, geographic location, and construction item classification.

11. The method of claim 1, further comprising:
storing, via the processor, the generated cost estimate and associated specification fields in a project database;
receiving, via the processor, actual cost data for the construction item from the completed construction project;
comparing, via the processor, the actual cost data to the generated cost estimate to determine an estimation variance;
analyzing, via the processor, the estimation variance to identify specification fields contributing to the variance; and
adjusting, via the processor, intelligent default values and confidence scoring parameters based on the analysis to improve accuracy of future cost estimates.

12. The method of claim 1, further comprising processing, via the processor, a plurality of construction items associated with the construction project, wherein:
receiving natural language descriptions for each of the plurality of construction items;
performing steps (b) through (f) for each construction item to generate individual cost estimates;
aggregating the individual cost estimates to generate a total project cost estimate;
identifying dependencies between construction items and sequencing the items according to construction logic; and
presenting the total project cost estimate with a breakdown by construction item, including confidence indicators for each item based on the confidence scores of the underlying specification fields.

13. The method of claim 5, wherein presenting the first, second, and third cost estimates comprises:
displaying, via the processor, the three cost estimates in a comparative format showing cost variance between options;
for each specification field that differs between the three specification sets, displaying, via the processor, the specific values and explaining the cost impact of the difference;
highlighting, via the processor, any specification fields in the economy specification set that were constrained by context-aware constraint rules and displaying the minimum allowable values; and
providing, via the processor, a selection interface enabling the user to select one of the three options or to customize specification values within the displayed ranges.

14. A system for generating construction cost estimates, comprising:
a processor;
a memory coupled to the processor and storing instructions that, when executed by the processor, cause the system to perform the method of claim 1;
a user interface coupled to the processor that is configured to receive natural language descriptions from a user and present cost estimates and questions to the user;
a specification database coupled to the processor that stores construction specification codes, material specifications, and dimension standards organized by construction item classification;
a pricing database coupled to the processor that stores current material costs and labor rates organized by geographic region and updated at intervals of 24 hours or less; and
a language model interface coupled to the processor and that is configured to communicate with an artificial intelligence language model for extracting specification fields and assigning confidence and cost impact scores.

15. A non-transitory computer-readable medium storing instructions that, when executed by a processor, cause the processor to perform the method of claim 1.

16. A computer-implemented method for generating a cost estimate for a construction item associated with a construction project, the method comprising:
receiving, via a user interface, a natural language description of the construction item from a user;
extracting, using a processor, at least one specification field from the received natural language description, wherein the at least one specification field is selected from the following: a quantity of the construction item, a material type of the construction item, a dimension of the construction item, a quality specification of the construction item, and an application context of the construction item;
assigning a confidence score to the at least one specification field, wherein the confidence score is selected from a plurality of pre-defined confidence scores, each pre-defined confidence score representing a level of information specificity for the construction item in the received natural language description;
assigning a cost impact score to the at least one specification field, wherein the cost impact score is selected from a plurality of pre-defined cost impact scores, each pre-defined cost impact score representing a level of potential cost variance for the construction item in the received natural language description; and
generating, via the processor, a cost estimate for the construction item based on the at least one specification field in response to a combination of the confidence score and the cost impact score satisfying a predetermined criteria, and displaying the cost estimate via the user interface; or
generating, via the processor, one or more requests for additional information about the construction item in response to the combination of the confidence score and the cost impact score not satisfying the predetermined criteria, and displaying the one or more requests for additional information via the user interface.

17. The method of claim 16,
wherein the confidence score is one of the following:
a high confidence score indicating that there is no ambiguity in information contained in the at least one specification field;
a medium confidence score indicating that information in the at least one specification field can be inferred from the received natural language description;
a low confidence score indicating that there is uncertainty about the information contained in the at least one specification field; and
a no confidence score indicating that there is insufficient information in the at least one specification field; and
wherein the cost impact score is one of the following:
a critical cost impact score indicating that a cost for the construction item cannot be obtained from information contained in the at least one specification field;
a high cost impact score indicating that a cost for the construction item may vary by 20% or more based on the information contained in the at least one specification field;
a medium cost impact score indicating that a cost for the construction item may vary by 10% - 20% based on the information contained in the at least one specification field; and
a low cost impact score indicating that a cost for the construction item may vary by less than 10% based on the information contained in the at least one specification field.

18. The method of claim 17,
wherein the predetermined criteria is not satisfied when either of the following occur:
the at least one specification field has a confidence score of NO and a cost impact score of CRITICAL; or
the at least one specification field comprises two specification fields and each specification field has a confidence score of NO and a cost impact score of HIGH; and
wherein generating, via the processor, one or more requests for additional information about the construction item comprises generating one or more targeted questions directed to the at least one specification field having a confidence score of NO or LOW and a cost impact score of CRITICAL or HIGH, and displaying the one or more targeted questions via the user interface.

19. The method of claim 17, wherein the predetermined criteria is satisfied when the at least one specification field has a confidence score of MEDIUM and a cost impact score of CRITICAL or HIGH, and wherein the method further comprises generating, via the processor, one or more confirmation questions about the generated cost estimate and requesting user verification via the user interface.

20. The method of claim 18, further comprising:
receiving, via the user interface, a response to the one or more targeted questions;
updating, via the processor, the at least one specification field using the received response;
reassigning, via the processor, a confidence score to the updated at least one specification field;
reassigning, via the processor, a cost impact score to the updated at least one specification field;
generating, via the processor, a cost estimate for the construction item based on the updated at least one specification field in response to a combination of the reassigned confidence score and the reassigned cost impact score satisfying the predetermined criteria, and displaying the cost estimate via the user interface; or
generating, via the processor, one or more requests for additional information about the construction item in response to the combination of the reassigned confidence score and the reassigned cost impact score not satisfying the predetermined criteria, and displaying the one or more requests for additional information via the user interface.

21. The method of claim 20,
wherein the predetermined criteria is not satisfied when either of the following occur:
the at least one specification field has a confidence score of NO and a cost impact score of CRITICAL; or
the at least one specification field comprises two specification fields and each specification field has a confidence score of NO and a cost impact score of HIGH; and
wherein generating, via the processor, one or more requests for additional information about the construction item comprises generating one or more targeted questions directed to the at least one specification field having a confidence score of NO or LOW and a cost impact score of CRITICAL or HIGH, and displaying the one or more targeted questions via the user interface.

22. The method of claim 16, wherein generating, via the processor, one or more requests for additional information about the construction item is limited to a maximum of three iterations.

23. The method of claim 22, wherein, after the three iterations, if the predetermined criteria is not satisfied, the method further comprises:
generating a preliminary cost estimate with an uncertainty indicator reflecting missing information; and/or
displaying, via the user interface, a notification identifying the at least one specification field that remains unresolved and a potential cost impact.

24. The method of claim 16, wherein generating, via the processor, the cost estimate for the construction item further comprises retrieving contextual data for the at least one specification field, the contextual data comprising one or more of:
industry-standard default specifications associated with the construction item type and building classification;
regional building code requirements for the geographic location associated with the construction project, including seismic zone requirements, climate considerations, and local amendments;
historical project data from similar construction projects, including specification patterns and actual costs for comparable items; and
current material costs and labor rates for the geographic region associated with the construction project, retrieved from a pricing database updated at intervals of 24 hours or less.

25. The method of claim 16, wherein generating, via the processor, the cost estimate for the construction item further comprises augmenting the at least one specification field with current market data including one or more of:
material cost information updated on a daily basis;
labor rates adjusted according to union contract cycles and prevailing wage requirements for the geographic region;
building code requirements updated on an annual basis; and
equipment costs adjusted based on current fuel prices and equipment availability.

26. A system for generating construction cost estimates, comprising:
a processor; and
a memory coupled to the processor and storing instructions that, when executed by the processor, cause the system to perform the method of claim 16.

27. A non-transitory computer-readable medium storing instructions that, when executed by a processor, cause the processor to perform the method of claim 16.

28-44. (canceled)
